(19) United States
(12) Patent Application Publication
(10) Pub. No.: US 2014/0188758 A1
(43) Pub. Date: Jul. 3, 2014

(54) METHODS AND SYSTEMS FOR IDENTIFYING FINANCIAL NEEDS AND PROVIDING CUSTOMIZABLE FINANCIAL ADVICE

(71) Applicant: The Western and Southern Life Insurance Company, Cincinnati, OH (US)

(72) Inventors: McKenzie M. Harper, Cincinnati, OH (US); Thomas M. Eck, Maineville, OH (US); Doug Ross, Cincinnati, OH (US); Thomas J. Wood, Cincinnati, OH (US); Keith Payne, Maineville, OH (US); Matthew Vovk, Cincinnati, OH (US)

(73) Assignee: The Western and Southern Life Insurance Company, Cincinnati, OH (US)

(21) Appl. No.: 13/733,047

(22) Filed: Jan. 2, 2013

(51) Int. Cl. G06Q 40/06

(52) U.S. Cl. CPC G06Q 40/06
USPC 705/36 R

(57) ABSTRACT

The system and method of the centralized integrated software for assisting agents in providing financial advice and product recommendations to clients based on financial needs is disclosed. The centralized software includes integrated applications for identifying various financial needs, priorities, and urgencies, and calculating survivor and retirement needs and various metrics based on rankings of various factors presented by the user. The centralized software includes an interactive interface for use for data gathering of client information. A module is identified for further input of user information based on the financial needs, priorities, and urgencies of the user.

### BACKGROUND

The present invention relates to systems and methods for financial planning and advice systems and, more specifically, for interactive tools for assisting professionals in providing and delivering financial-related services for optimizing client wealth, retirement needs, and related matters.

Software has been used in the field of insurance-related financial services to improve the quality of service and automate aspects of retirement planning. Such software, for example, is able to enter in client information and factor in rates of return, return on investment, and assets, to calculate the amount of retirement income that will likely be generated for a client. Insurance and financial services professionals can use these estimations in providing advice regarding potential products for clients.

However, existing software platforms are unsatisfactory in several regards. For example, existing software provides an automated calculator that includes current assets and liabilities, existing contributions, and present-value returns to generate a retirement scenario. As clients have grown sophisticated with the wealth of information available, insurance related businesses and financial services have also improved in the type of products provided by various companies including full service companies such as the Western & Southern Financial Group. The existing software approach to retirement planning is very linear, in that it cannot account for the various desires and wishes of a broad spectrum of clients, including factoring in changing views on such issues.

For example, certain clients place importance on certain factors in their life at any given point in time which could impact their views and planning for retirement. For example, a couple recently married in their late twenties may focus on such life events as having a baby, buying a home, or other similar goals. Other families may focus more on transferring wealth at a certain time, including either to charities or to their families, or make a large purchase, or need to care for their elderly parents. Existing software platforms cannot account the importance and priority to each of these life events in retirement and other needs-based planning for recommendations on financial products. As such, there exists a need for software that integrates the various priorities and urgencies of various life events in financial planning.

Additionally, existing software used by agents in providing financial services lacks an accountability element to determine whether the software influenced an investment or purchase decision of the client in the financial group's portfolio of products. As such, there is additional need for software that provides a system and method of determining the affected outcome on the purchasing decision of a client based on the use of the software.

Furthermore, existing systems are also limited in that the financial software cannot be changed to address making a determination of a goal not presently provided in the software. Thus, there is a need for software which can add modules regarding financial advice and planning and impact to a client's profile based on unidentified needs.

### SUMMARY

The system and method of the present invention is a centralized integrated software for assisting agents in providing financial advice and product recommendations to clients based on financial needs.

The centralized software includes integrated applications for identifying various financial needs, priorities, and urgencies, and calculating survivor and retirement needs and various metrics based on rankings of various factors presented by the user.

The centralized software includes an interactive interface for use for data gathering of client information. The client information is stored in locally stored records. The centralized software can include one or more records for storing client information. The locally stored record is available to all modules. Throughout the use and operation of the centralized software, the locally stored record is available for editing and storing the client's information.

The centralized software further includes a presentation layer which integrates the various informational presentations that agents may use in providing financial services. These presentations may be launched in various sections of the centralized software without having to leave the software. The presentations assist the agent in assessing a client's financial needs.

The centralized software further includes a path finder that assists a client in identifying priorities and urgencies of various life events for a client. The centralized software provides systems and methods to integrate the priorities and urgencies of these various life events in evaluating various financial plans and recommendations.

The path finder, along with the integrated presentations, enable an agent providing financial services and a client requesting financial services to identify the priorities and urgencies for that client within the centralized software and tailor the additional modules based on the client's priorities and urgencies. With the implementation of the path finder and the presentation layer within the software, the software provides a roadmap for the client as to the module the client and agent should access.

The centralized software further includes modules for assessing a client's needs and recommendations in terms of wealth planning. Such modules include a Protection module, an Accumulation module, and a Post-Retirement module. The Protection module includes a sub-module for assessing survivor needs which identifies immediate cash needs and ongoing income needs in the case of a loss of wage earner. The Protection module further includes a sub-module for assessing mortgage needs to provide an approximation of the existing balance of the mortgage loan and options in the event of a wage earner's death to determine how the family could remain in the home. The Accumulation module includes a sub-module for assessing retirement needs which identifies the desired retirement income amount and accumulates the current personal savings plus future contributions to determine when, if at all, the client will experience a shortfall of their desired retirement income during their retirement. The Post-Retirement module includes a sub-module for retirement income which identifies the amount of retirement income desired for a user. The Post-Retirement module includes a sub-module for wealth transfer that determines the impact of a wealth transfer on retirement or wealth accumulation.

The centralized software is not limited to the above modules. The modules are illustrative of the capabilities of the centralized integrated software and allows for the development of additional modules based on growth and development of financial planning tools.

The centralized software also includes a capability of generating reports that are configured to include results from multiple modules, such as the client's current protection and needs. The report can include an assessment section specifying a client's particular retirement needs and predict whether and to what extent a client is likely to reach that scenario.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Further features of the invention, its nature and various advantages will be more apparent from the following description, taken in conjunction with the accompanying drawings:

FIG. 1 is a diagram that is illustrative of a display page for implementing the interactive methods and systems in accordance with the centralized software;

FIG. 2 is a flow chart illustrating an embodiment for installing the centralized software;

FIG. 3 is a flow chart illustrating an embodiment for the architecture for the operation of the overall functionality for the centralized software;

FIG. 4 is an illustrative embodiment of the operation of a typical module for the centralized software;

FIGS. 5A-5C are diagrams of illustrative display pages for entering in client information;

FIG. 6 is an illustrative embodiment of the Path Finder;

FIG. 7A-FIG. 7F are diagrams of illustrative display pages for implementing interactive methods and systems for the centralized software;

FIG. 8A-FIG. 8D are diagrams of illustrative display pages for implementing interactive methods and systems for the centralized software;

FIG. 9A-FIG. 9G are diagrams of illustrative display pages for implementing interactive methods and systems for the centralized software;

FIG. 10A-FIG. 10G are diagrams of illustrative display pages for implementing interactive methods and systems for the centralized software;

FIG. 11 is an illustrative display page for implementing interactive methods and systems for the centralized software;

FIG. 12 illustrates a flow-chart for an exemplary operation of the centralized software.

### DESCRIPTION OF PREFERRED EMBODIMENTS

The following disclosure presents, describes, and teaches various exemplary embodiments in sufficient detail to enable those skilled in the art to practice the invention, and it should be understood that other embodiments may be realized without departing from the spirit and scope of the invention. Thus, the following detailed description is presented for purposes of illustration only, and not of limitation, and the scope of the invention is defined by the appended claims.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), system management RAM (SMRAM), one or more processing resources such as a central processing unit (CPU) or hardware or software control logic, ROM, and/or other types of nonvolatile memory. Additional components of the information handling system may include a storage management initiative standard interface (SMI), one or more disk drives, one or more network ports for communication with external devices, and various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

The following description is intended to be exemplary of a high-level system architecture that implements the centralized software and components of the present invention.

The centralized software, labeled as Financial Focus™, includes various components for processing, use, and installation of the centralized software on preferably a personal computer such as laptop, workstation, or other type of computer equipment that includes a suitable interface for implementing the centralized software on an information handling system. These components include the Web Application, Install EXE, Service Local, Install MSI, Install Base, and Logging Service.

The Web Application component is the user application which provides the interactive interface comprising the front-end of the software.

The Install EXE component comprises the .NET application to assist in the installation and launching of the Web Application.

The Service Local component monitors the network connection and sends user logs to a networked computer located remotely, such as a home office location.

The Install MSI component installs and sets up the applications for the centralized software.

The Install Base component installs miscellaneous programs for the centralized software.

The Logging Service component is a web service that receives user logs from the centralized software that have been created by agents in the field.

The following is a further description of these components with reference to the figures.

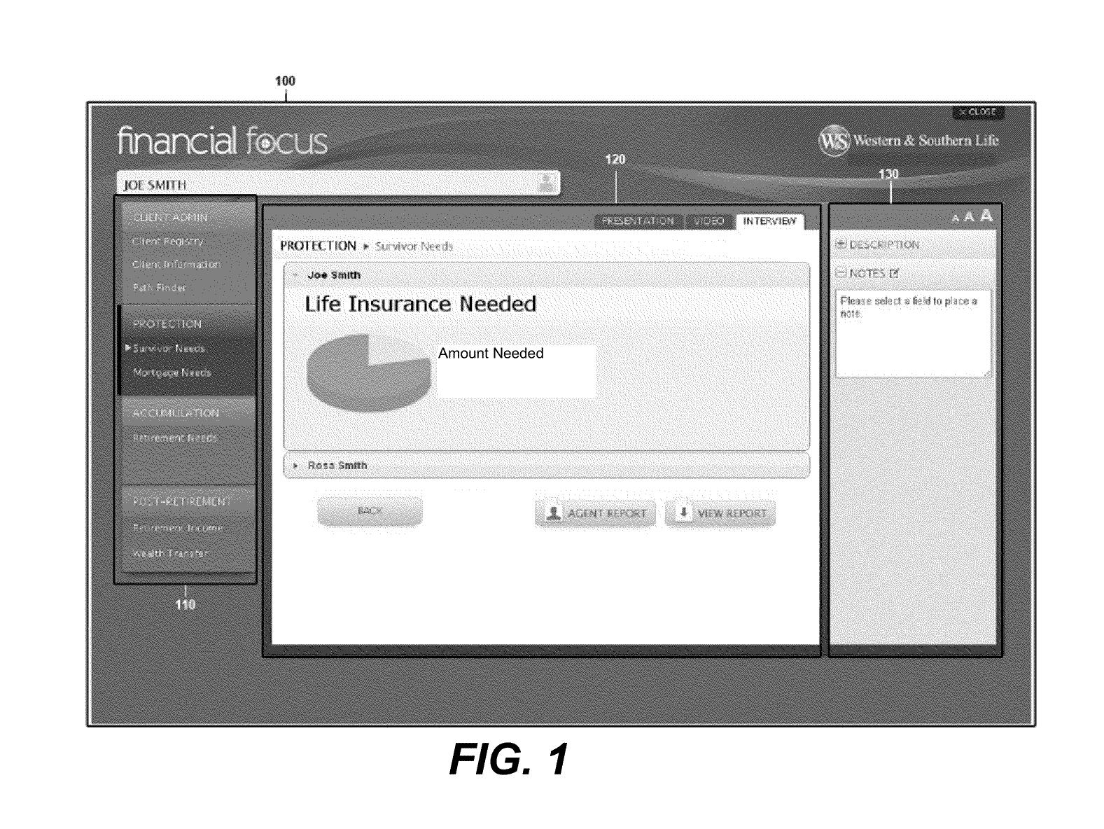

The Web Application is the software that provides the interactive interface for the user. The Web Application is a locally hosted application. FIG. 1 provides a screenshot of the centralized software 100 that provides an interactive interface for a user, such as a client or an agent. The centralized software 100 interactive interface includes three major panels. The module bar 110 is the first of such panels and identifies the available modules for the centralized software 100. The modules include links that allow for user interactivity and input for the various categories of financial planning available by the centralized software. One such example is a module for entry of client records. The interactive interface allows for the generation of a New Record to enter in the financial profile of a client. The records store client information. The client records are stored as text files, with a file extension of .INI. The client records are stored locally on the storage medium for the information handling system. The interactive interface further contains a central panel 120 that provides for information display or client entry. The central panel 120 reflects the actions performed by the user interacting with the various options available for the centralized software and allows for such tasks as data entry, selection, and information presentation. The interactive software further includes a notes panel 130 which provides a description of the selection of the present tool selected by a user and a notes field for entry of notes.

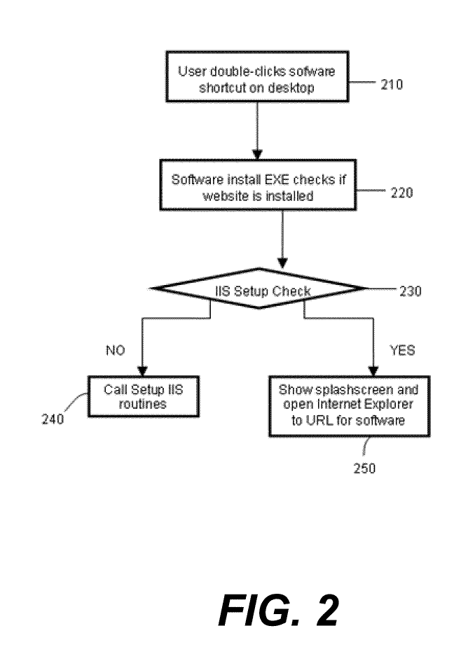

FIG. 2 is a block diagram to illustrate an exemplary embodiment of the installation routine for the centralized software. In an exemplary embodiment, each personal computer containing the centralized software may have a link on the desktop. As shown in 210, a user may double-click the software shortcut on the desktop. At step 220, the software component Install EXE checks if the website is installed. At step 230, if the IIS Setup has not occurred 232, the software routine calls setup routines to set up the IIS routines as known to those of ordinary skill in the art. After the installation, the software 250 launches the splash screen in Microsoft Internet Explorer® for the centralized software by navigating to the Universal Resource Locator for the centralized software. If the IIS Setup has occurred 234, the splash screen for the software is opened in Microsoft Internet Explorer® in full screen mode as described above for step 250.

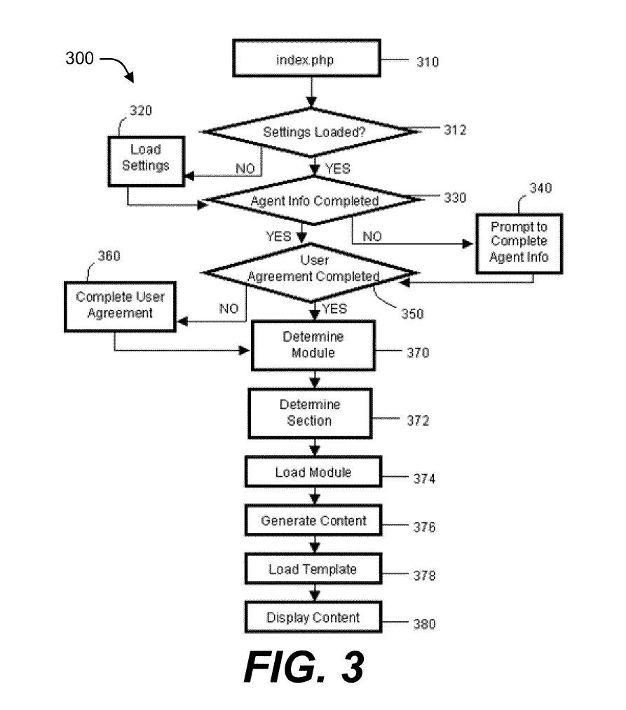

FIG. 3 is an illustrative embodiment for the architecture for the operation of the overall functionality for the centralized software 300. Once the user launches the centralized software, the index.php 310 determines whether any settings have been loaded for the software 312. If settings have not been loaded, the centralized software prompts the user to enter or load settings 320. After the settings have been loaded 320, the centralized software determines if the agent information is complete 330. If the settings have already been loaded, the centralized software skips to checking whether the agent information is completed 330. If the agent information is not completed, the centralized software prompts the user to complete the agent information 340. If the agent information has already been completed, the centralized software skips to checking if the User Agreement is complete 350. If the User Agreement has not been completed, the centralized software prompts the user to complete the User Agreement 360. Once the User Agreement has been completed, the centralized software determines the appropriate module 370. If the User Agreement has already been completed 354, the centralized software skips to 370 determining the module or worksheet. Within the module or worksheet, a user may select the appropriate section 372 desired. At step 374, the centralized software loads the appropriate module and then at 376 generates the appropriate content for presentation to the user. Step 378 loads the template for selected module 370 and displays content 380 to the user.

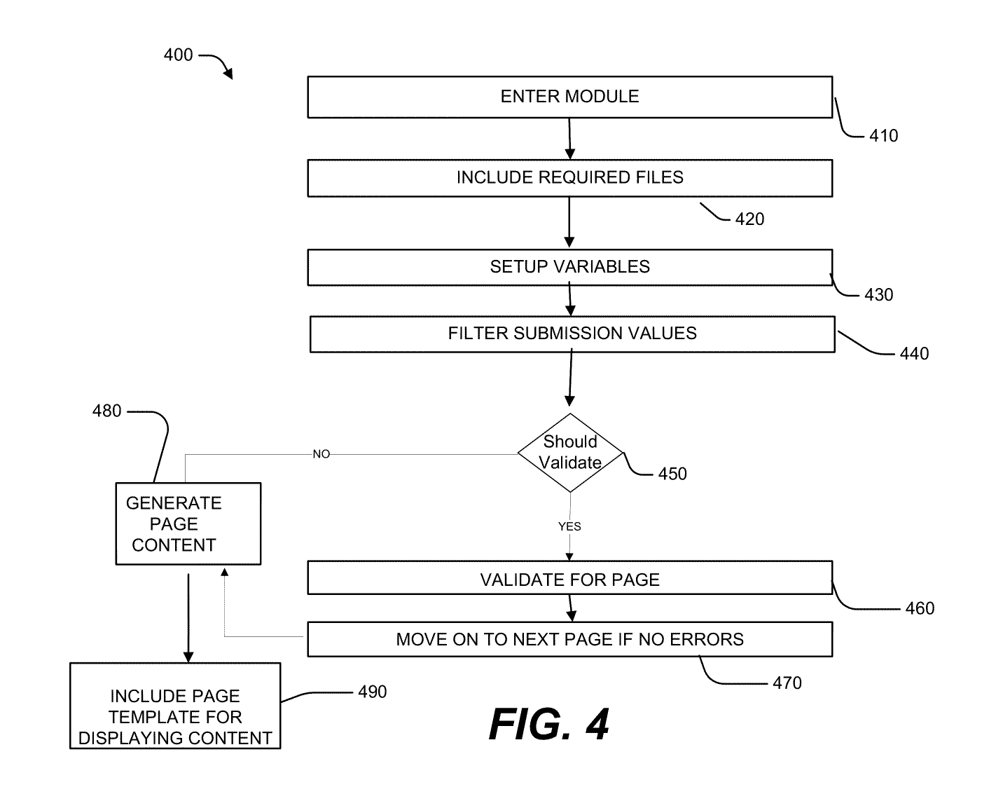

FIG. 4 is an illustrative embodiment of the operation of a typical module for the centralized software 400. Once a user selects a particular module from the module bar 110, the centralized software enters the module 410. The centralized software confirms that the required files are included 420 for that module. The centralized software further provides the setup of the variables for the module 430. Once the user values have been entered, the module filters submission values 440. The filter for each module checks whether the user entry of the information should be validated 450 per the parameters for that module. For example, a module such as survivor needs may request information on the financial needs of a family. An alphabetical entry in this field would not be validated, but a numerical entry within a range would be validated. If the information entered by a user for that module is validated, the page entry 460 is next checked for validation. If no errors occur for that module, the module moves on to the next page 470. The centralized software then generates page content 480 for the next page includes the page template for displaying content 490. Alternatively, if the information submitted by the user is not validated, the centralized software generates the page content 480 and includes the page template for displaying content 490 for that page.

The Install EXE file is a .NET console program that is deployed with the centralized software onto the personal computer. It serves to assist in installing portions of the centralized software, as well as launching the centralized software when a user clicks on the desktop icon for the centralized software. The Install EXE file may contain files or known commands to setup the centralized software. As an exemplary embodiment, the following files may be included with the centralized software to assist in the installation and uninstallation functions. As an example, a WebSiteSetUp file may be present to allow for setup of the centralized software on a website in the IIS. Additionally, a jQuerySetUp file may be present to set up the jQuery website in the IIS. A ConfigureIIS file may be present which runs the WebSiteSetUp and the jQuerySetUp files. UninstallWebsites may also be present to run the uninstall of the centralized software off of the website installed on IIS. A DataFileSetup may be present to create folders and set permissions as needed for the centralized software. An InstallService may be present to install the centralized software logging windows service. An UninstallService may be present to uninstall the centralized software logging windows service. The centralized software may also have an Open command to open the centralized software in Microsoft Internet Explorer®.

The Service Local component for the centralized software provides a service which checks for usage logs generated by the Web Application to upload them to the remote central office. The remote central office may be a home office for an insurance or financial services company that is able to receive reports and logs from all of the various agents deployed in the field.

The Service Local runs locally on the user's personal computer with the centralized software. Once the Local Service has been initiated on the personal computer containing the centralized software, the Local Service determines if the personal computer is in a network connected to the remote home office. If the personal computer is within the range of the network for the remote home office, the Service Local checks whether the centralized software has files to upload. If files are located, then the Local Service assists in uploading the files, logging the upload, and moving the files to a processed folder on the local personal computer.

The Install MSI component is a Microsoft® Software Installer package that installs various components of the centralized software. The Install MSI component installs the Web Application, the Install EXE, and the Service Local for the centralized software. The Installer checks to ensure that .NET 3.5 is installed on the personal computer. If the personal computer has .NET 3.5 installed, the Installer deploys the necessary files and folders for the Web Application, Install EXE, Service Local, and associated libraries.

The Install Base component is a .NET program that may download and install a collection of native installers needed for the centralized software to run on the personal computers. A user navigates to the installer URL and for each install item, launches the Install Mode for the particular item which installs the file.

The Logging Service is a .NET WCF web service that receives the Usage Logs for the centralized software, processes those logs, and saves them to a Database such as an Oracle® database. The website for the Logging Service may be password-protected and require authentication as is known to those of ordinary skill in the art.

The module bar 110 includes modules for the entry of client information and modules associated with the three pillars of financial security: Risk Protection, Accumulation, and Post-Retirement. The centralized software may have within these modules sub-modules for providing financial advice with respect to these pillars including assessing Survivor Needs, Mortgage Needs within Risk Protection, Retirement Needs within Accumulation, and Retirement Income and Wealth Transfer within Post-Retirement. These modules and sub-modules are intended as exemplary modules for the centralized software and the software may be expanded to include additional modules as needs for the company's clients expand.

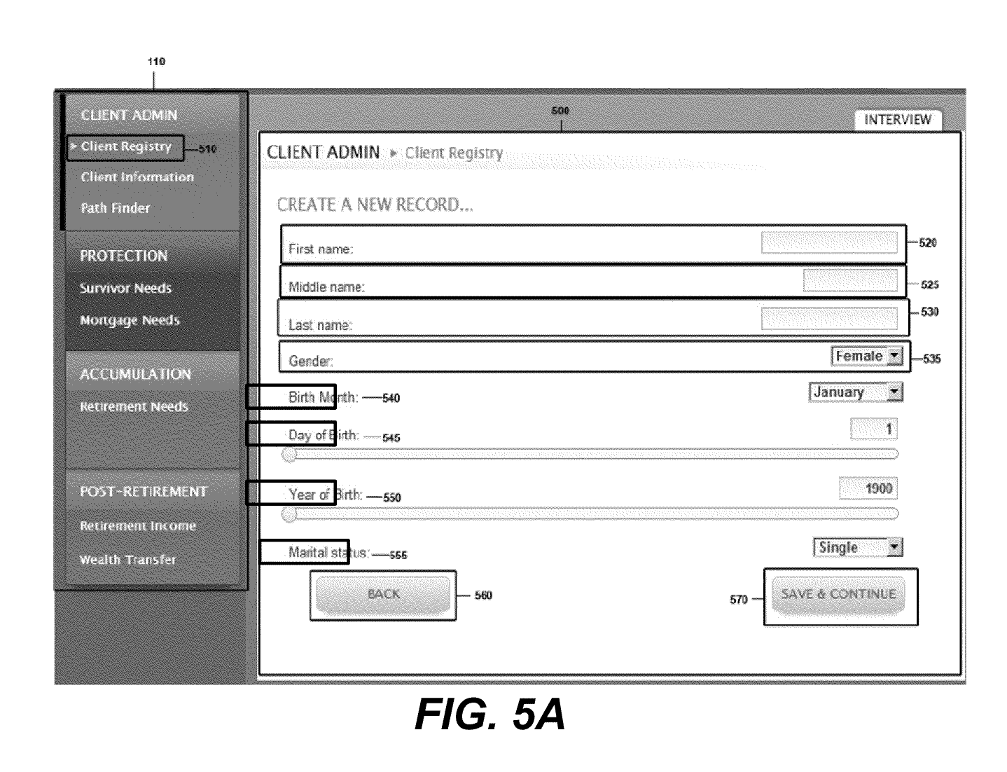

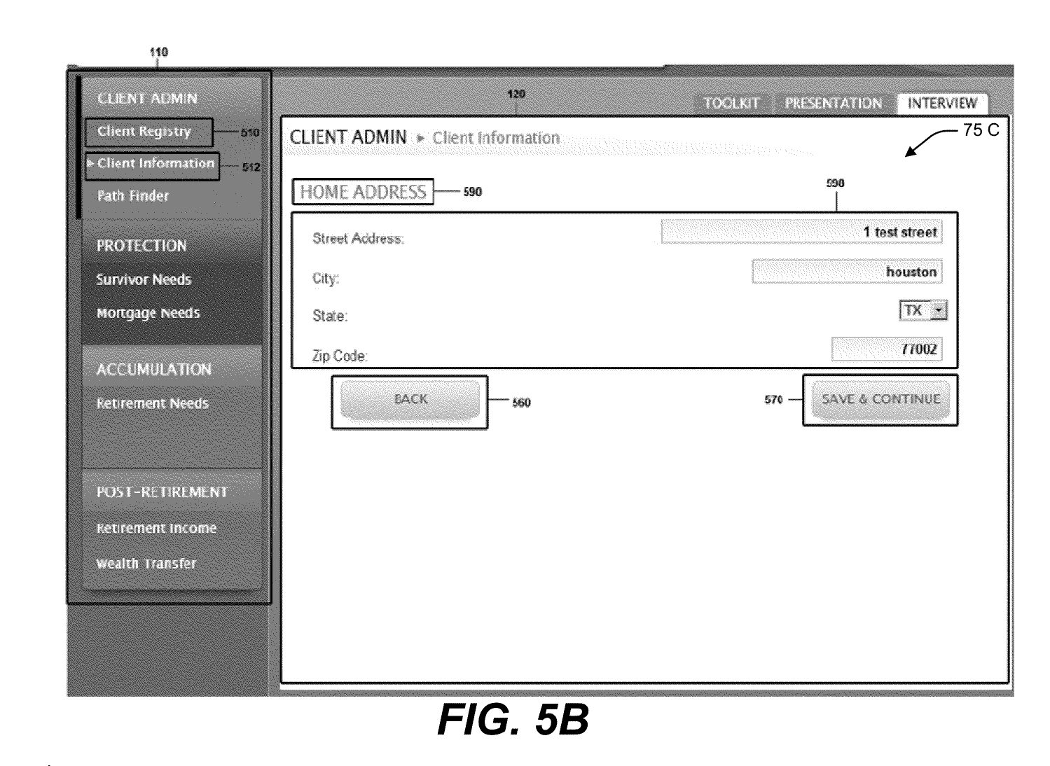

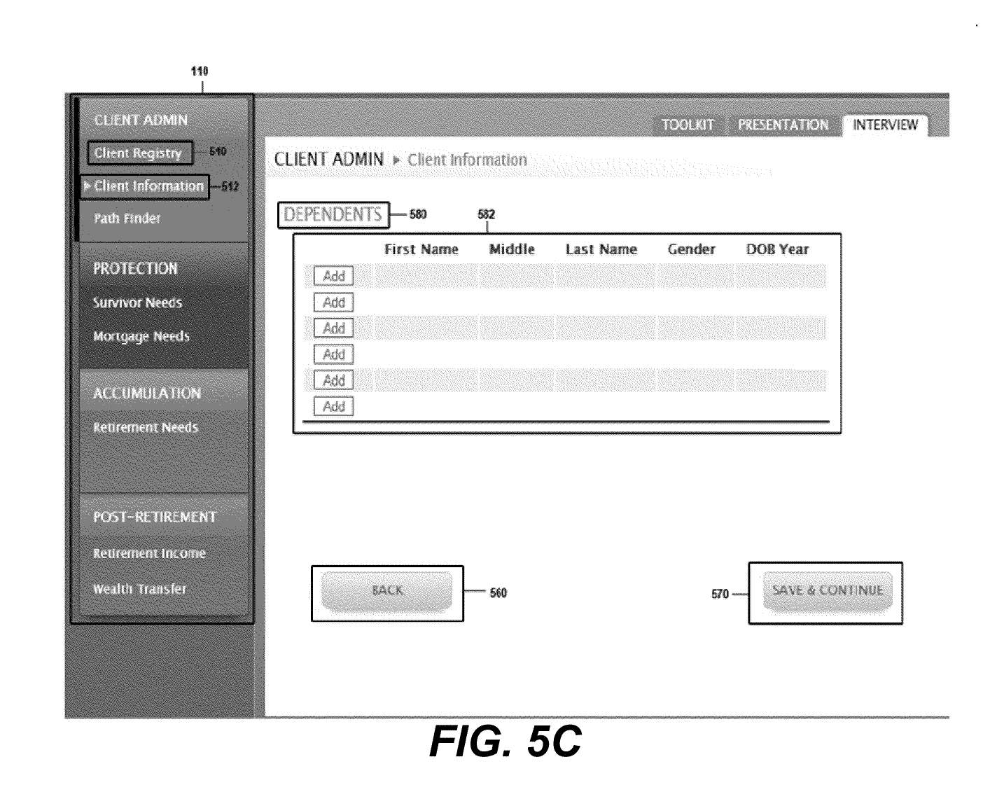

FIGS. 5A-5C are an exemplary embodiment of generating a local record for a client. As shown in FIG. 5A, the module bar 110 contains a sub-module titled Client Registry 510. When a user clicks on Client Registry 510, it launches a screen in the central panel 120 that provides options for a user to choose to load an Existing Record or load a New Record. When the user clicks on New Record, the central panel 120 launches a Create a New Record 500 screen. The Create a New Record 500 screen contains blanks for receiving client information, such as the First Name 520, Middle Name 525, Last Name 530, Gender 535, Birth Month 540, Day of Birth 545, Year of Birth 550, and Marital Status 555. The Create a New Record 500 also contains buttons that enable the information entered to be saved by pressing Save & Continue 570. The Back 560 key allows the user to go back to the previous screen. Once the Save & Continue 570 button is pressed by a user, the central panel 120 provides a screen for entering the address information for the client.

FIG. 5B is an additional screen for input of client information such as the Home Address 590. Fields for Street Address, City, State, and Zip Code 598 are present in the Home Address screen. The module bar 110 also includes a Client Information 512 link. Once a user clicks on Save & Continue 570, the centralized software advances to the next panel for entry of client information.

FIG. 5C is an additional screen for input of Dependents 580 for the client. The fields available for client input of Dependents 580 include various fields 582 associated with Dependents 580 such as, for example, first name, middle and last name, gender, and date of birth for the dependent of the client.

Once the user finishes adding the Dependents, the Save & Continue 570 button will next transport the user to the Path Finder

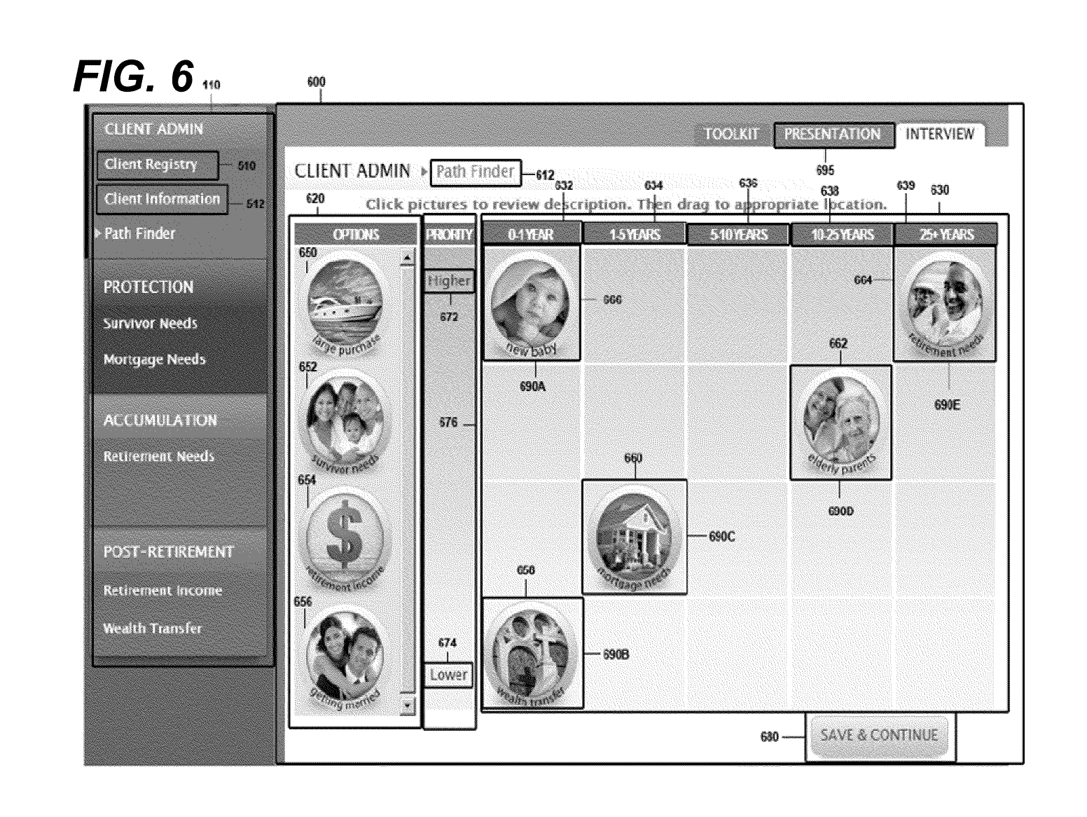

FIG. 6 is an illustrative embodiment of the Path Finder 612 which allows a user to categorize the client's needs based on the client's financial priorities and urgencies. The Path Finder may also be accessed at any point by selecting the Path Finder 610 sub-module in the module bar 110. The various financial needs are presented in the Options 620 and include, for example, large purchase 650, survivor needs 652, retirement income 654, getting married 656, wealth transfer 658, mortgage needs 660, elderly parents 662, retirement needs 664, and new baby 666. Such needs are meant only to be illustrative and are not meant to be limiting for the centralized software. A person of ordinary skill in the art may identify additional needs and the software contemplates including additional icons for representing those needs in Options 620. The user of the centralized software may select to input any number of financial needs from the Options 620 and categorize them by Priority 670. The Priority 670 is a sliding vertical scale whereby the user can place the need Higher 672 or Lower 674 depending on the financial priority for that need. Other implementations of the Priority 670 are within the spirit and scope of the present invention. A user of the centralized software may further categorize the urgencies for the financial needs by placing them in the appropriate block for Urgency 630. Example time periods presented in Urgency 630 include 0-1 Year 632, 1-5 Years 634, 5-10 Years 636, 10-25 Years 638, and 25+ Years 639.

An exemplary embodiment for a user inputting the appropriate financial priorities and urgencies for a client is illustrated in this client's Path Finder layout 600. For this client's layout 600, for example, the client has identified a high priority for the new baby 666 need within 0-1 Year 632 by placing the new baby 666 need in the appropriate box 690A. Within 1-5 Years 634, the client has a medium to low need for mortgage needs 660 and has specified as much by making the entry 690C. Within 10-25 Years 638, the client has a medium to high need to care for elderly parents and has specified as much by making the entry in 690D. After 25+ years, the client will have a high need for retirement needs 664 and has specified as much by making the entry for that need as shown in 690E.

Once the agent and the client have identified the financial priorities and urgencies for the client's financial needs, the agent and client can discuss the appropriate module for further interaction. The centralized software integrates the identification process for the financial priorities and urgencies to provide a framework for the next module for interaction without having to exit the software or pull up other presentations, forms, or materials. The identification of the financial priorities and urgencies for a client is integrated with the centralized software using the Path Finder.

FIG. 6 also shows an exemplary embodiment of the presentation layer, in which all presentations related to the financial advice is integrated within the centralized software. For example, FIG. 6 includes Presentation 695 which launches a slideshow presentation within the software to further discuss the purpose for Path Finder. Within the presentation layer, for example, the centralized software may integrate the appropriate presentations for each module and sub-module within a tab on the central panel 120 for that respective module or sub-module. The centralized software can use the presentation layer, and in particular, the Presentation 695 along with the Path Finder 612 to identify which financial pillar the client would most benefit from and direct the user to the respective module and sub-module for further interaction.

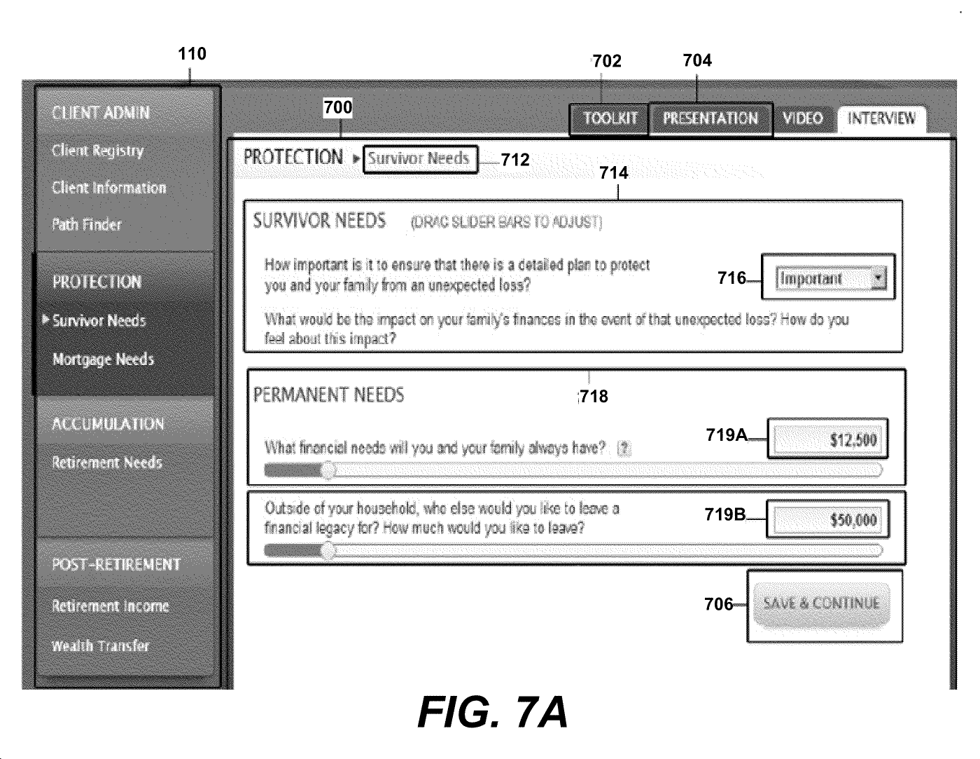

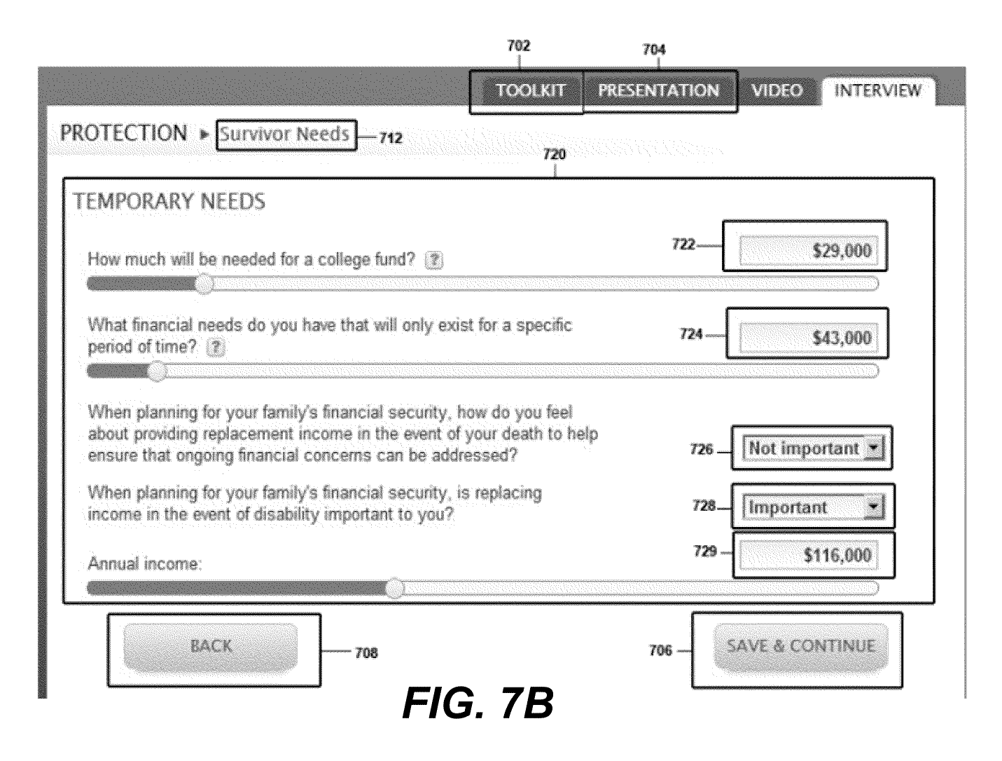

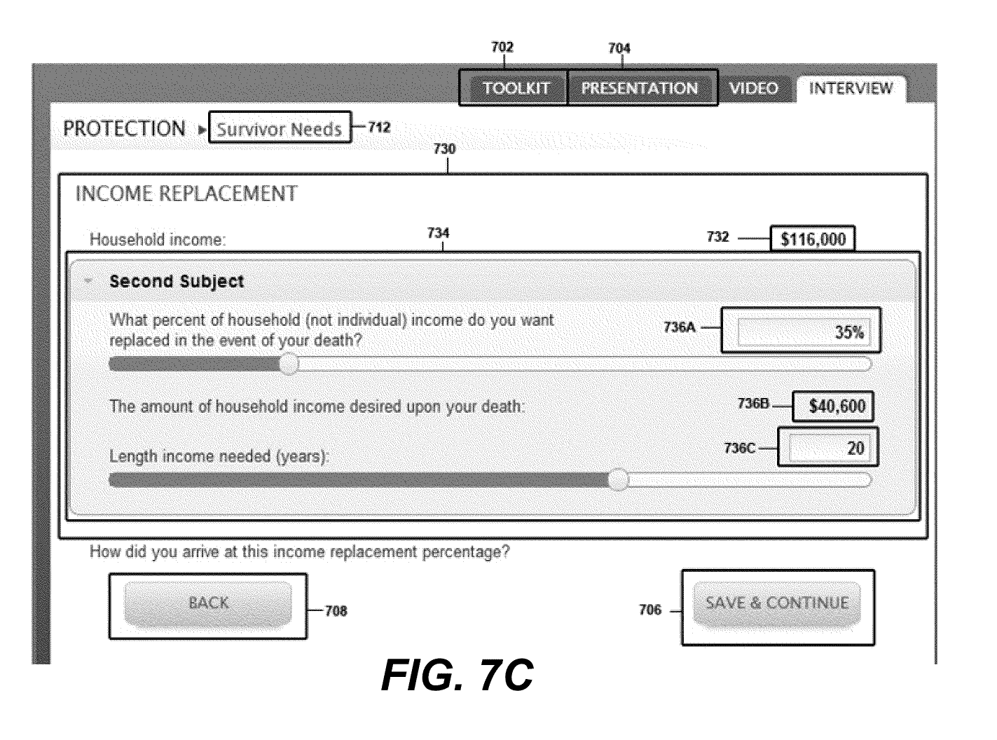

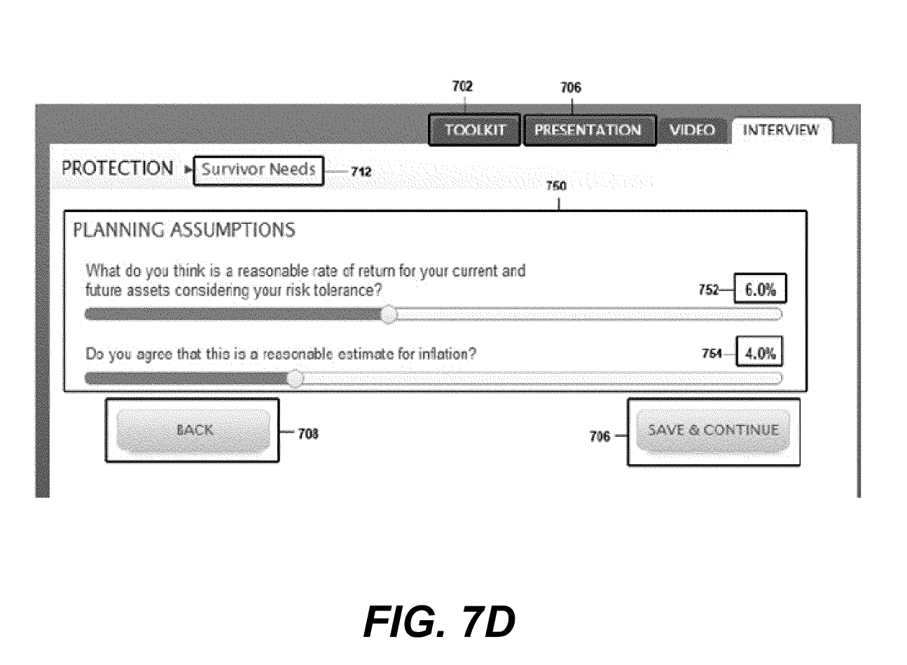

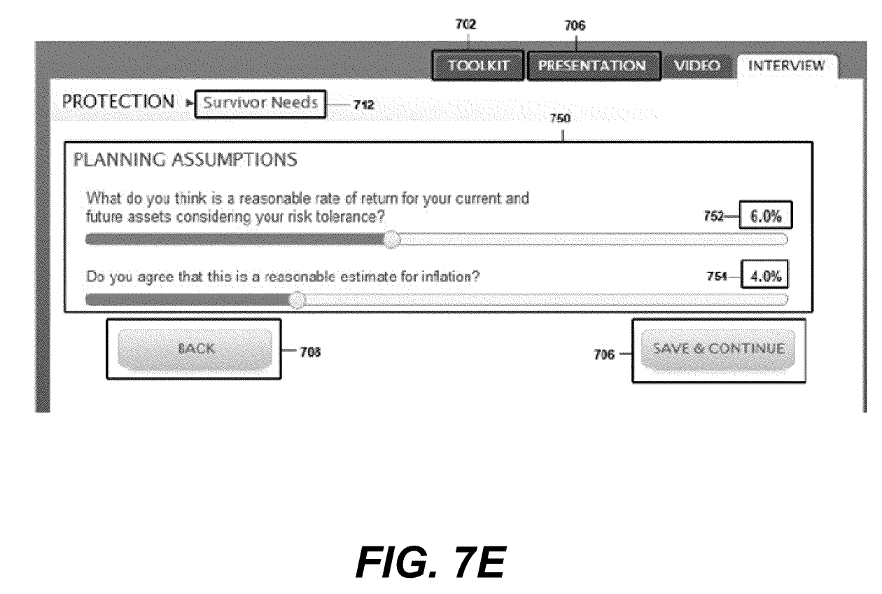

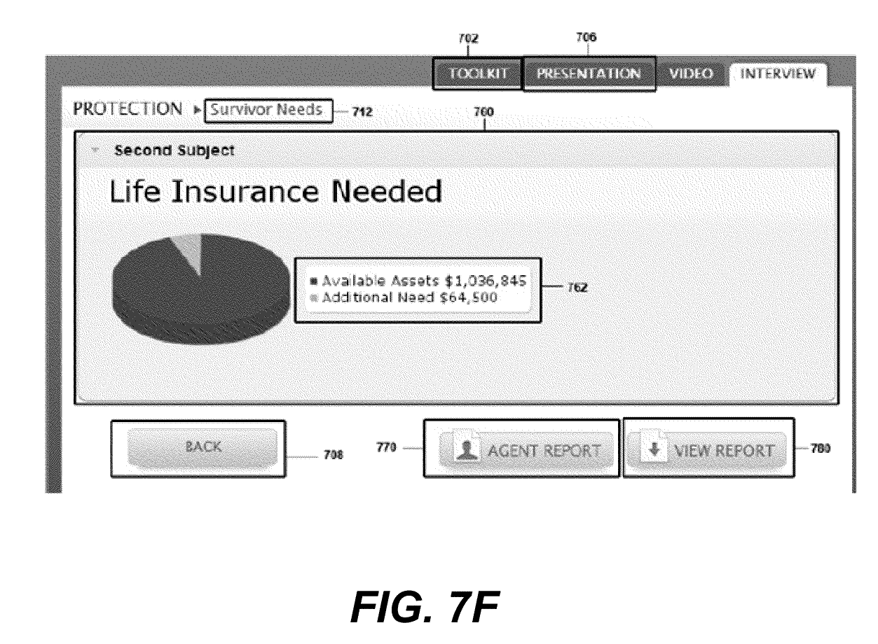

FIG. 7A-FIG. 7F are diagrams of illustrative display pages for implementing interactive methods and systems for the centralized software. In particular, FIG. 7A-FIG. 7F illustrate the Survivor Needs sub-module 712 in accordance with an embodiment of the centralized software. The Survivor Needs 712 sub-module may be accessed by clicking Survivor Needs 710 link in the module bar 110.

Survivor Needs separates the capital need into two purposes. The first purpose is the immediate cash needs. The user may input immediate cash needs by completing the entry screens. Examples of immediate cash needs are provided. The second purpose includes ongoing income needs. Ongoing income needs are calculated by projecting the client's current earnings at an assumed inflation rate to the clients' assumed retirement date. Then, these cash flows are discounted to the present. The immediate cash needs and ongoing income needs (which have been discounted) are added. This total sum is compared to the existing financial assets the clients have available to provide income to the survivor. If the difference between the total sum is greater than the existing financial assets, the clients have a shortfall and need to consider additional financial capital to help cover the financial needs of the survivor.

FIG. 7A illustrates an exemplary embodiment of a client's layout of survivor needs 700. Survivor Needs 712 for a client may be entered within this sub-module. The Survivor Needs Questions 714 determines the priority a user places on unexpected loss by categorizing the survivor needs field 716 as Important or Not Important. Other options may be listed in the survivor needs field. The Permanent Needs 718 seeks information regarding ongoing income needs by a client as illustrated in the permanent needs fields 719A and 719B. A user can select Save & Continue 706 to advance to the next screen for Survivor Needs 712.

A budget worksheet is further presented within the centralized software by Toolkit 702 for the client to determine typical and customary expenses.

FIG. 7B illustrates the Temporary Needs 720 for Survivor Needs 712. Temporary Needs 720 may include, for example, college fund 722, temporary financial needs 724, and questions regarding financial security 726 and replacement income 728. The Temporary Needs 720 further requests the client's annual income 729 which will be used to calculate the amount that will be needed for evaluating Survivor Needs 712. A user may go Back 708 to the previous screen or move to the next Survivor Needs 712 screen by clicking Save & Continue 706.

FIG. 7C illustrates the Income Replacement 730 for Survivor Needs 712. The Household Income 732 is used from FIG. 7B and the client is prompted to enter in the percentage of the income to replace in the event of death 736A, amount of household income desired upon the death of an income earner 736B, and the length the income would be needed in years 736C. A user may go Back 708 to the previous screen or move to the next Survivor Needs 712 screen by clicking Save & Continue 706.

FIG. 7D illustrates the Available Income and Assets 740 for Survivor Needs 712. The screen requests the user to enter assets available upon death 742, social security total income upon death 744, available income upon death 746, and the amount of household income desired upon death 748 to make calculations. A user may go Back 708 to the previous screen or move to next Survivor Needs 712 screen by clicking Save & Continue 706.

FIG. 7E illustrates the Planning Assumptions 750 for Survivor Needs 712. The screen requests the user to enter what the client thinks is a reasonable rate of return 752 and reasonable estimate for inflation 754. These values are used to make the Survivor Needs 712 calculation. The rate of return 752 is also saved for use in other modules to provide further integration. A user may go Back 708 to the previous screen or move to the next Survivor Needs 712 screen by clicking Save & Continue 706.

Each of the entries for amounts and related fields include slide bars to select an amount rather than perform manual input.

Each of the questions further link to a notes panel similar to the notes panel 130 in which a user can enter in notes or questions or access the descriptions for the module. The notes panel is not shown for the individual modules in the figures.

FIG. 7F illustrates and identifies the shortfall and Life Insurance Needed 760 for Survivor Needs 712. The centralized software uses the information provided in FIGS. 7A-7E to calculate the available assets and additional need 762 upon death. The Survivor Needs adds the immediate cash needs and ongoing income needs and compares that amount to the existing financial assets the client has available to provide income to the survivor. Based on the difference, the centralized software determines a shortfall and provides recommendations such as the need for additional life insurance to add financial capital to help cover the financial needs of the survivor.

The centralized software further generates an Agent Report 770. The Agent Report 770 provides a summary of the current financial needs of the client based on the financial priorities and urgencies for the client and the information provided in the Survivor Needs sub-module 710. The Agent Report illustrates at a quick glance for the Agent all the questions and answers throughout the module.

The centralized software further generates a client report by View Report 780 that can be presented immediately to the client. The client report presents an analysis of the financial needs selected and identified by the client and can greatly influence and direct the client's decision in making financial decisions. For example, the report may put into perspective the needs for reviewing and ascertaining additional financial capital and legitimize the agent's recommendations. With solid reports integrated with the financial software, an agent has much greater flexibility and tools to service the financial needs for a client.

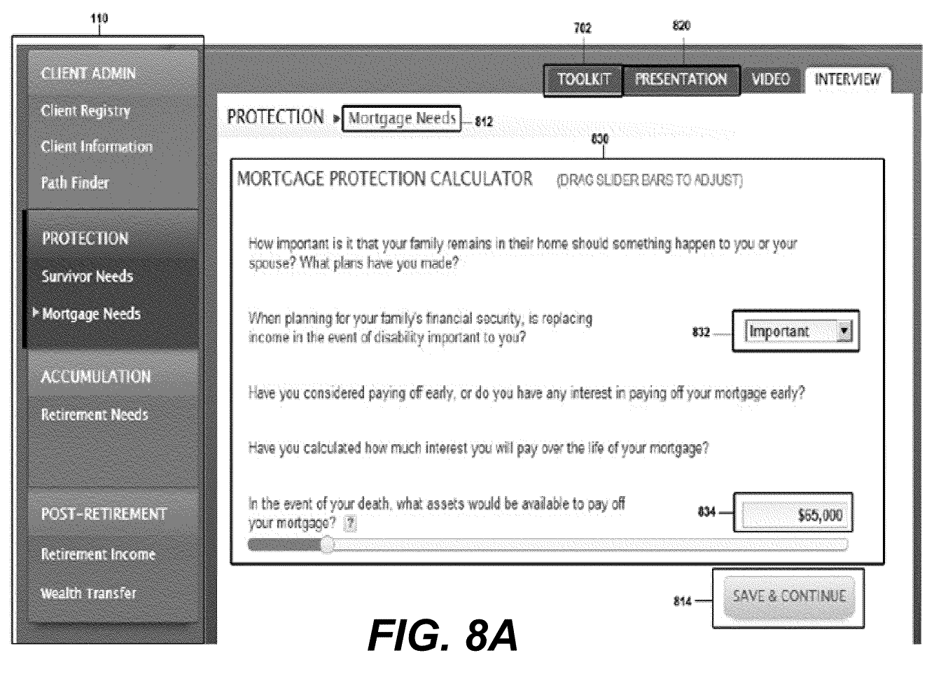

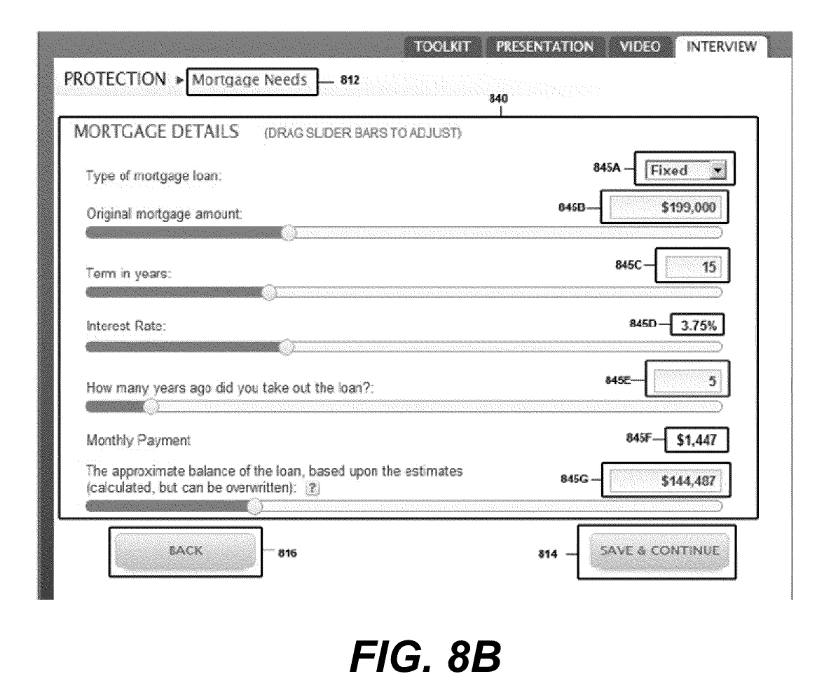

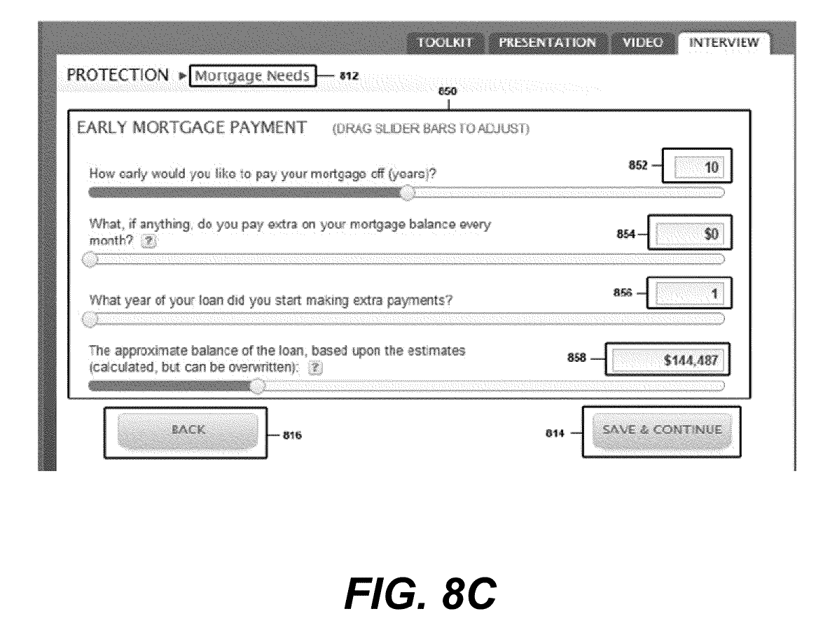

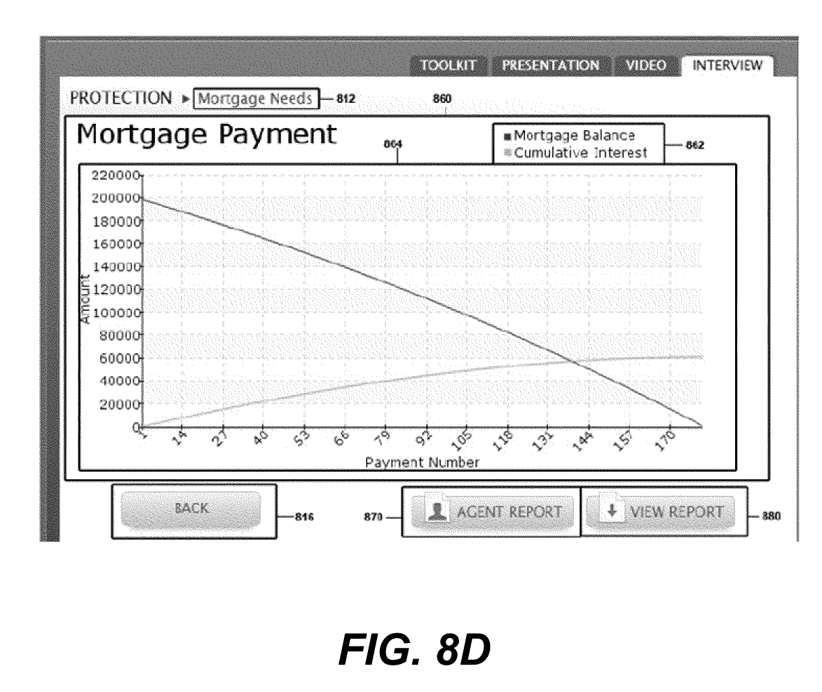

FIG. 8A-FIG. 8D are diagrams of illustrative display pages for implementing interactive methods and systems for the centralized software. In particular, FIG. 8A-FIG. 8D illustrate the Mortgage Needs sub-module 812 in accordance with an embodiment of the centralized software. The Mortgage Needs 812 sub-module may be accessed by clicking Mortgage Needs 810 link in the module bar 110.

The purpose of the Mortgage Needs sub-module 812 is to provide an approximation of the existing balance of the mortgage loan. The Mortgage Needs sub-module 812 further assists a client in determining how to keep their home in the event of death or disability.

FIG. 8A illustrates the Mortgage Protection Calculator 830 screen for the Mortgage Needs sub-module 812. The Mortgage Protection Calculator Screen requests information on identifying the importance of mortgage needs 832 and identifying assets available to pay off the mortgage 834. The toolkit 702 with a budget worksheet is also available in this sub-module.

FIG. 8A further illustrates the integration of the presentation layer. The Presentation 820 in the Mortgage Needs sub-module 812 will launch a customized presentation for evaluating the importance of mortgage and how to protect your family home in the event of the death of a wage earner. The Mortgage Needs sub-module 812 presents further information on how to pay off the mortgage early. A user may select Save & Continue 814 to advance to the next screen for the Mortgage Needs sub-module 812.

The centralized software may further include a video layer (not pictured). The video layer integrates a video customizable and accessible within each module that presents a voice presentation for the user regarding the respective module. The centralized software may integrate videos within each respective module that explains the concepts within that module. The video may be used, for example, in place of or in conjunction with the presentation for that module in ascertaining the client's financial needs, priorities and urgencies.

FIG. 8B further illustrates the Mortgage Details 840 screen for the Mortgage Needs sub-module 812. The user can enter in the details for the mortgage in the Mortgage Details 840 screen. Such details may include, for example, the type of mortgage loan 845A, the original mortgage amount 845B, the term 845C, the interest rate 845D, how long ago the loan was taken out 845E, the monthly payment 845F, and the approximate balance of the loan 845G. The approximate balance 845G may be calculated based on the information in fields 845A-845F but can also be overwritten by the user. A user may select Back 816 to return to the previous screen or advance to the next screen by selecting Save & Continue 814.

FIG. 8C illustrates the Early Mortgage Payment 850 screen for the Mortgage Needs sub-module 812. Example fields for the Early Mortgage Payment 850 screen include questions regarding how many years earlier the client would like to pay off the mortgage 852, extra payments 854, at what year the extra payments started 856, and the approximate balance of the loan 858. The approximate balance of the loan 858 is carried over from the entry in the approximate balance field 845G of FIG. 8B. A user may select Back 816 to return to the previous screen or advance to the next screen by selecting Save & Continue 814.

FIG. 8D illustrates the Mortgage Payment 860 screen for the Mortgage Needs 812. The Mortgage Payment 860 screen is based upon the entries of the user on the screens illustrated in FIGS. 8A-8C. As shown, The Mortgage Balance and Cumulative Interest 862 is displayed in a chart to identify the number of payments that will be required to pay off the mortgage. The Mortgage Needs sub-module 812 further generates an Agent Report 870 that includes a summary of the information entered by the client and provides options for amortization of the loan based on payments. The agent may use the report to provide further recommendations regarding financial needs for the client. The Mortgage Needs sub-module 812 further generates a client report by clicking View Report 880 that can be provided to the client and summarizes the mortgage needs for the client.

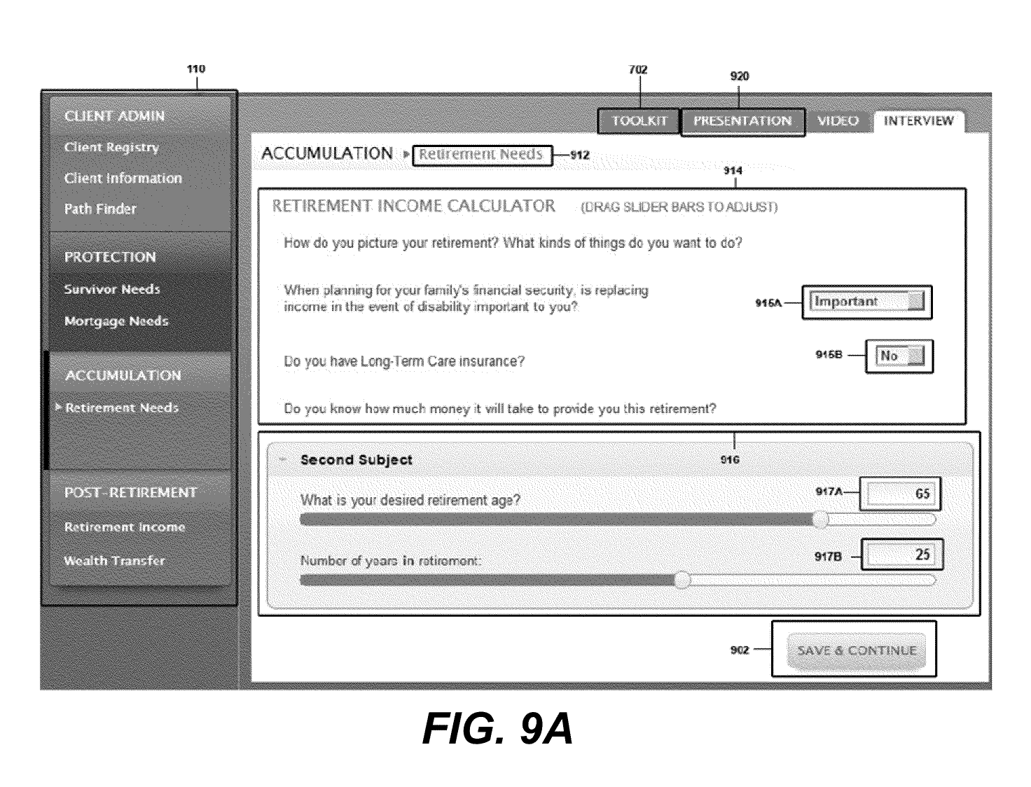

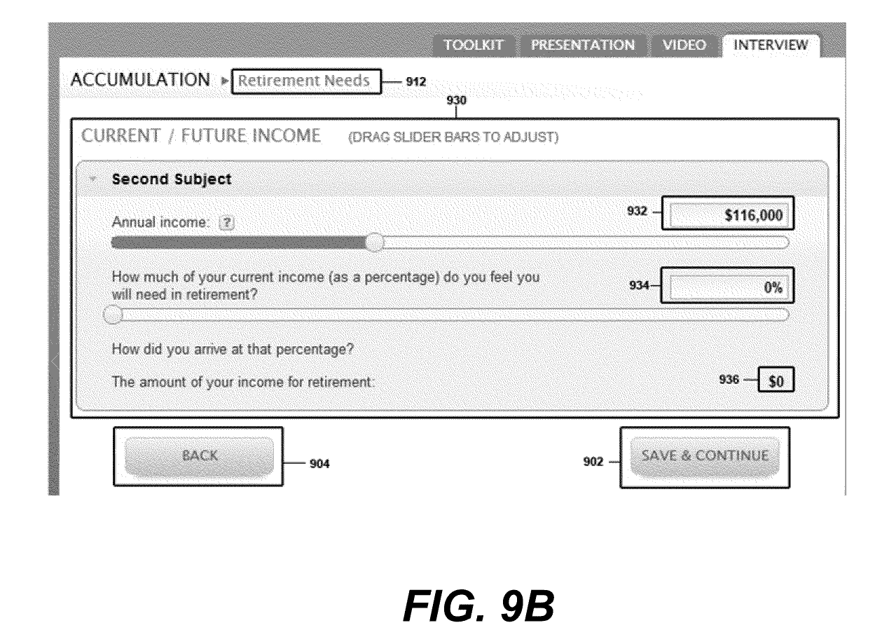

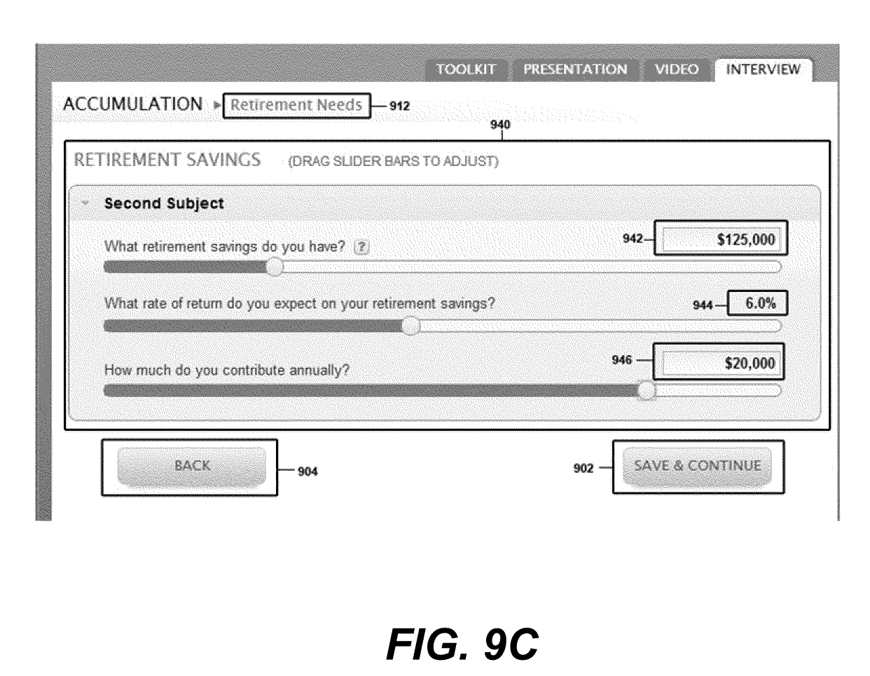

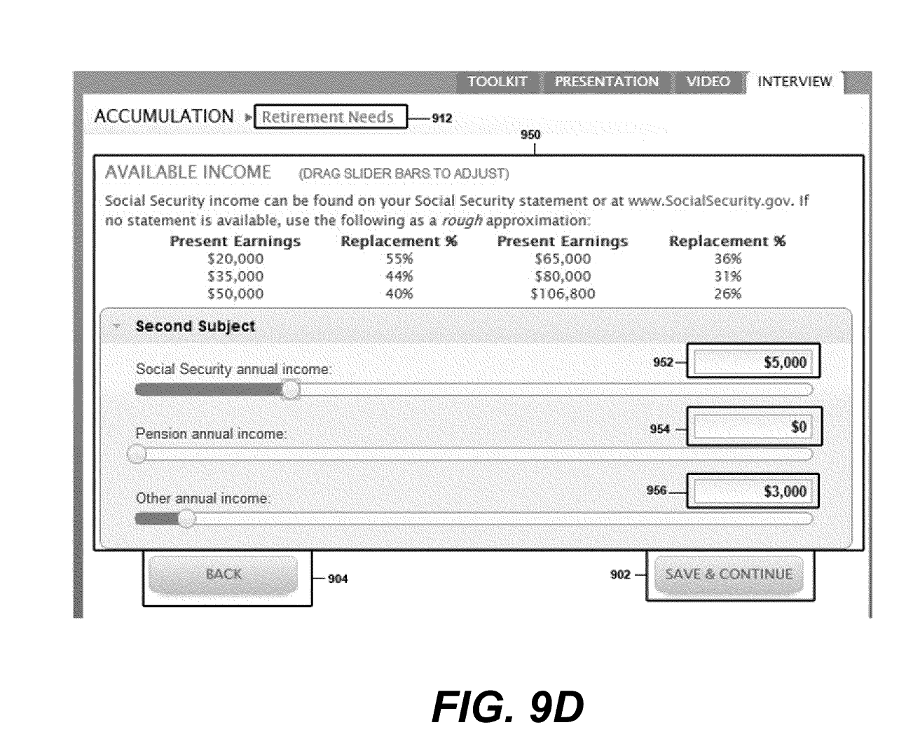

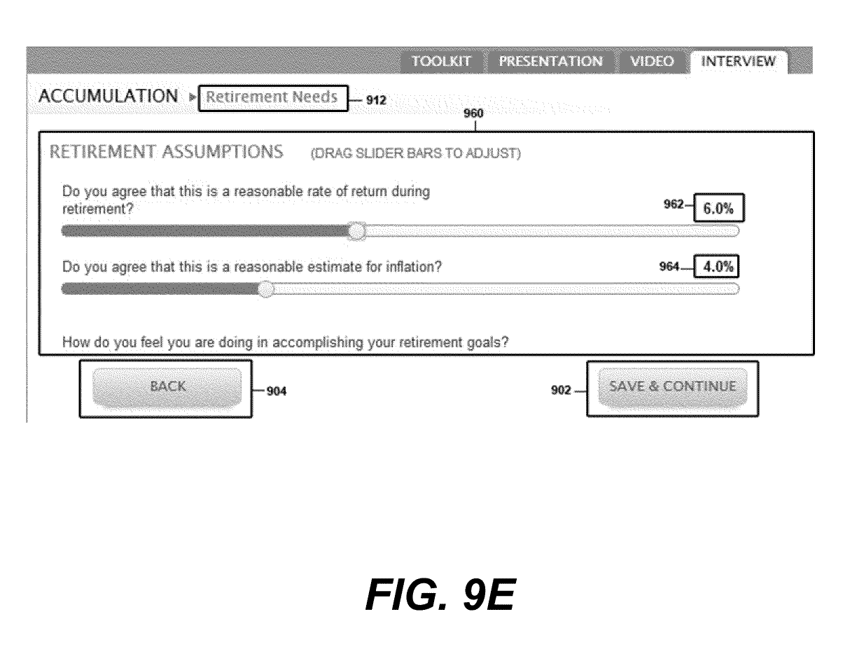

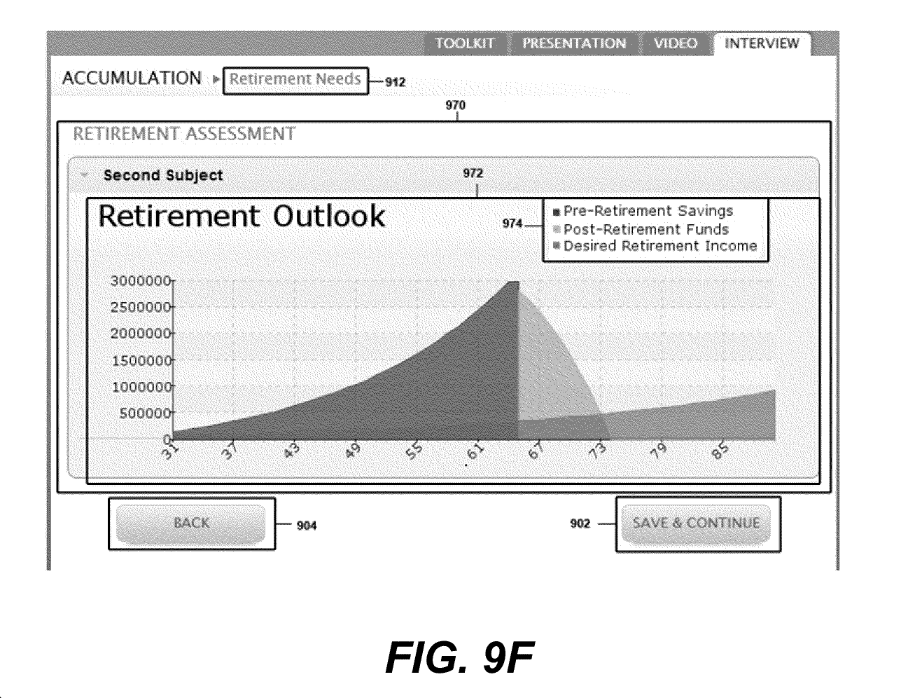

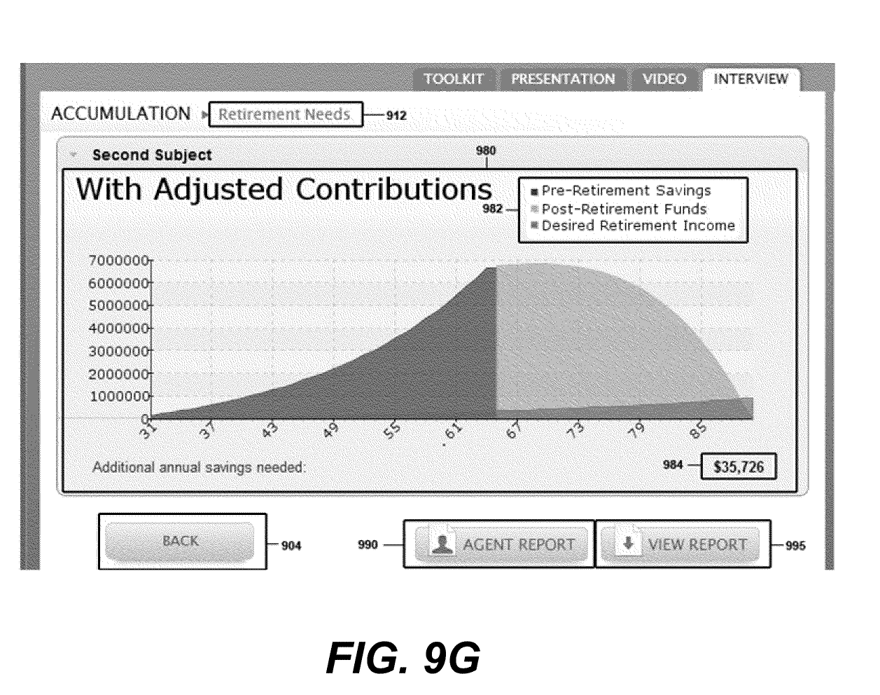

FIG. 9A-FIG. 9G are diagrams of illustrative display pages for implementing interactive methods and systems for the centralized software. In particular, FIG. 9A-FIG. 9G illustrate the Retirement Needs sub-module 912 in accordance with an embodiment of the centralized software. The Retirement Needs 912 sub-module may be accessed by clicking Retirement Needs 910 link in the module bar 110.

The Retirement Needs sub-module 912 provides an approximation of the amount of savings a client needs to provide the desired income in retirement. The user begins by entering a desired retirement income amount either as a dollar figure or as a percentage of current income. The desired retirement income amount is compounded using an assumed rate of inflation. The compounding begins at the current time period and continues through the assumed retirement years of the client. Retirement Needs sub-module 912 accumulates the current personal savings plus future contributions to the client's assumed retirement date. The user inputs the assumed social security income, pension income, and other income available for retirement. The difference between the desired retirement income and the income available from social security income, pension income, and other income is compared. Any shortfall is taken from the client's personal savings. This calculation is performed until no additional personal savings remains. If personal savings depletes before the end of the client's retirement years, the date when personal savings is depleted is returned to the client as the year when the projected retirement income is less than the desired retirement income. Additional contributions to personal savings are recommended in order to allow the personal savings amount to cover the shortfall through the client's retirement years. The additional contributions to personal savings is calculated and the client is directed to begin making additional contributions now.

FIG. 9A illustrates an exemplary embodiment of the screen for displaying the fields for determining the retirement needs for a client for the Retirement Needs sub-module 912. The Retirement Income Calculator 914 requests information from the user regarding importance of planning and replacing income in the event of disability 915A and information on long-term care insurance 915B. The user is also displayed fields by the centralized software to enter in desired retirement age 917A and number of years in retirement 917B in the second subject 916. The toolkit 702 with a budget worksheet is also available in this sub-module.

FIG. 9A further illustrates the integration of the presentation layer. The Presentation 920 in the Retirement Needs sub-module 912 will launch a customized presentation for evaluating the importance of retirement and how to properly address retirement needs. A user may select Save & Continue 902 to advance to the next screen for the Retirement Needs sub-module 912.

FIG. 9B illustrates the current and future income 930 screen for the Retirement Needs sub-module 912. The fields available for entry by the user for the current and future income 930 screen include, for example, annual income 932, percentage of income needed in retirement 934, and the amount of income for retirement 936. A user may select Back 904 to go to the previous screen or click Save & Continue 902 to advance to the next screen for the Retirement Needs sub-module 912.

FIG. 9C illustrates the Retirement Savings 940 screen for the Retirement Needs sub-module 912. The fields available for entry by the user for the retirement savings 940 screen include, for example, the amount of retirement savings for the client 942, the rate of return for those savings 944, and the annual contribution 946. A user may select Back 904 to go to the previous screen or click Save & Continue 902 to advance to the next screen for the Retirement Needs sub-module 912.

FIG. 9D illustrates the Available Income 950 screen for the Retirement Needs sub-module 912. The fields available for entry by the user for the available income 950 screen include, for example, the social security annual income 952, pension annual income 954, and other annual income 956. A user may select Back 904 to go to the previous screen or click Save & Continue 902 to advance to the next screen for the Retirement Needs sub-module 912.

FIG. 9E illustrates the Retirement Assumptions 960 screen for the Retirement Needs sub-module 912. The fields available for entry by the user for the retirement assumptions 960 screen include, for example, the rate of return 962 and the reasonable estimate for inflation 964. These may also be entered based on information entered in previous modules. A user may select Back 904 to go to the previous screen or click Save & Continue 902 to advance to the next screen for the Retirement Needs sub-module 912.

FIG. 9F illustrates the Retirement Assessment 970 screen for the Retirement Needs sub-module 912. The Retirement Assessment 970 screen includes a Retirement Outlook 972 chart that graphically illustrates Pre-Retirement Savings, Post-Retirement Funds, and Desired Retirement Income 974 on a map to identify any potential shortfalls in the Retirement Needs. A user may select Back 904 to go to the previous screen or click Save & Continue 902 to advance to the next screen for the Retirement Needs sub-module 912.

FIG. 9G illustrates a retirement assessment with Adjusted Contributions 980 screen. The retirement assessment with Adjusted Contributions 980 graphically illustrates Pre-Retirement Savings, Post-Retirement Funds, and Desired Retirement Income 982 on a map with the Adjusted Contributions in the form of additional annual savings 984 needed to balance the retirement needs of a client.

The Retirement Needs sub-module may further generate an Agent Report 990 that displays the client's current situation for retirement. Similarly, the View Report 995 link will generate a report for the client regarding the client's current situation for retirement. That is, the one or more reports will illustrate whether the amount of personal savings will be enough to cover any shortfall between their desired retirement income and income from Social Security, pension, and other income. If there is a shortfall, the one or more reports will display the amount of additional contributions necessary such that personal savings will be large enough to cover any shortfall.

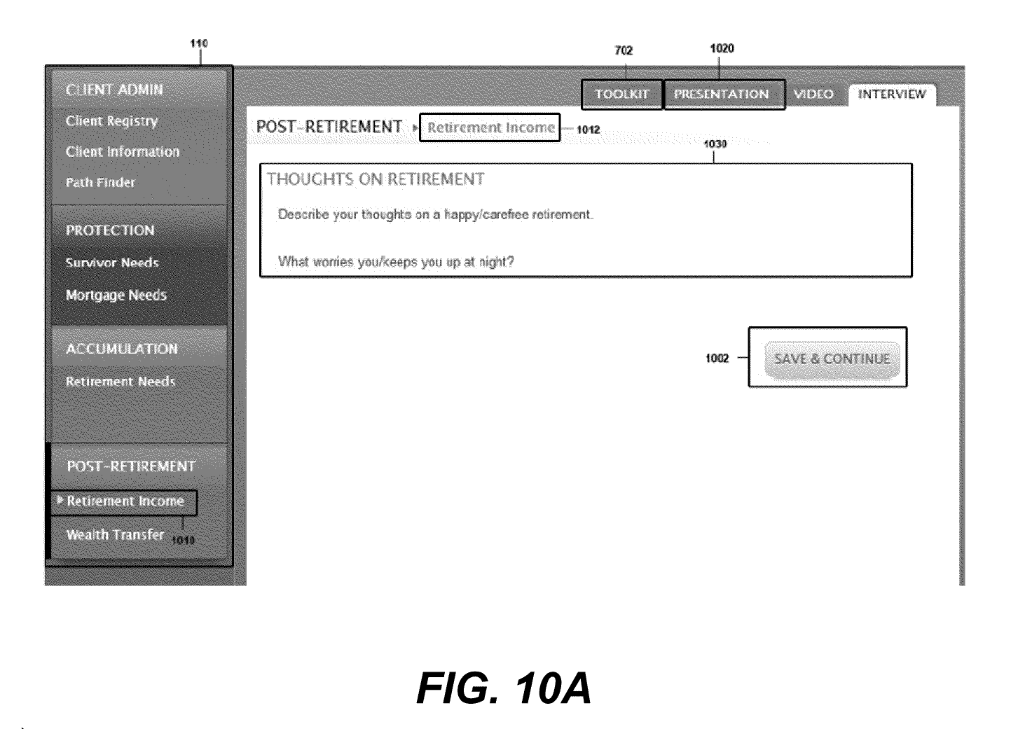

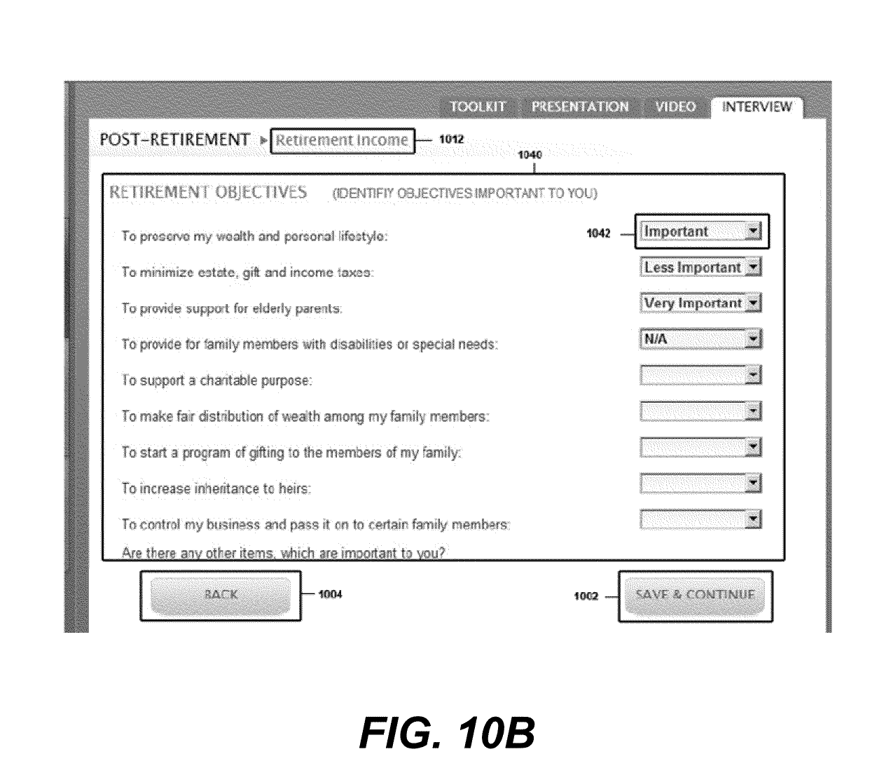

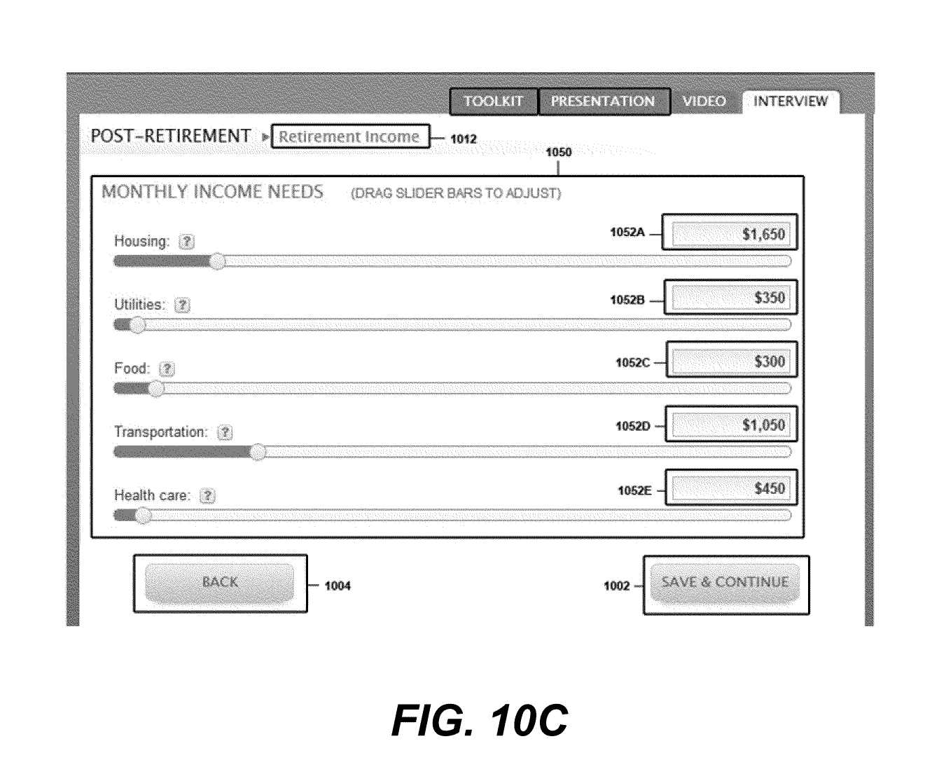

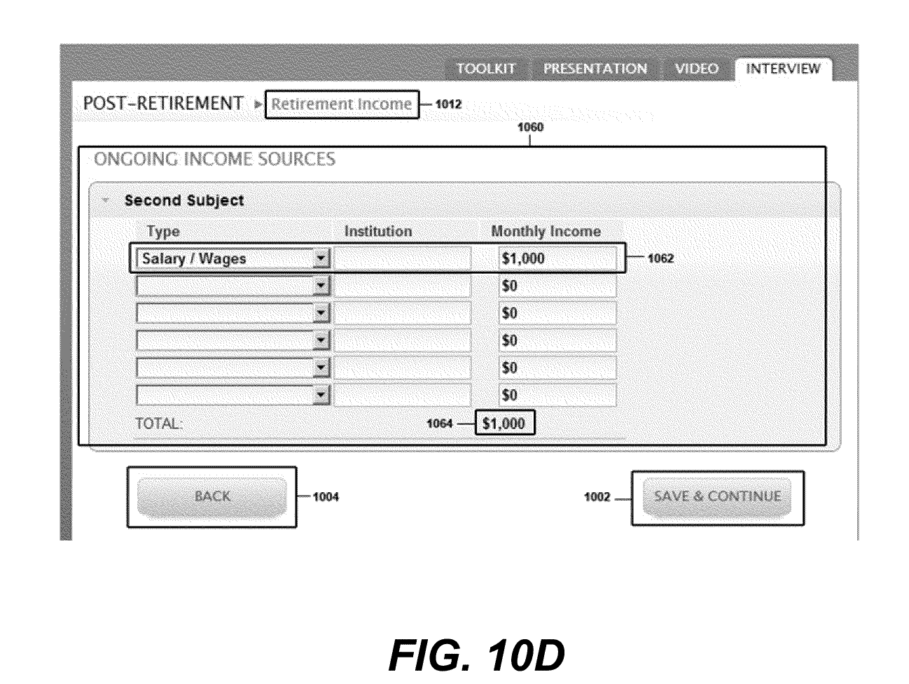

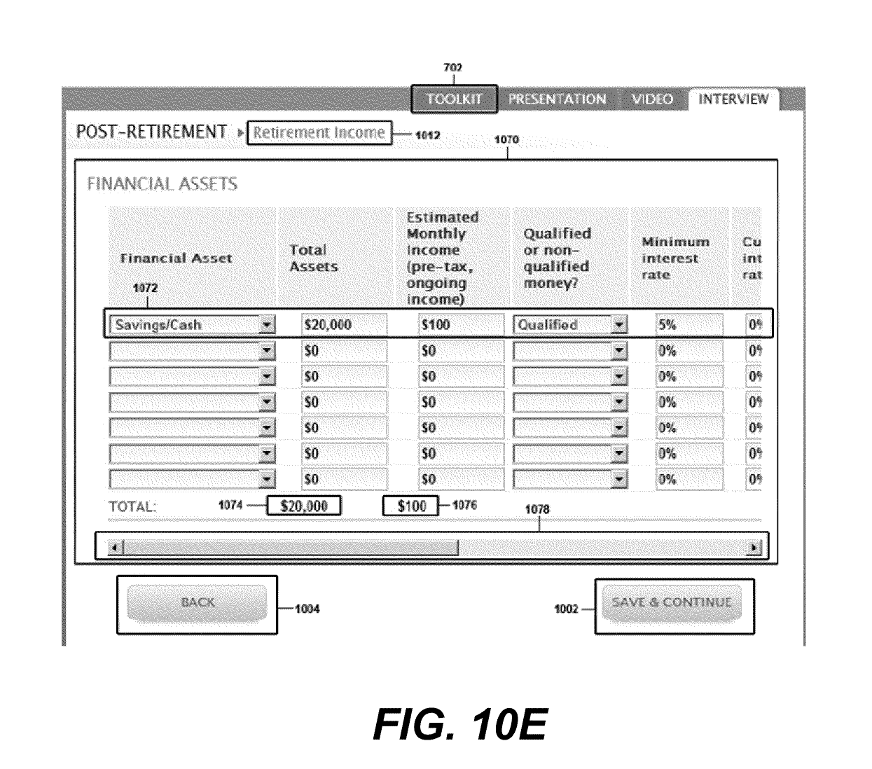

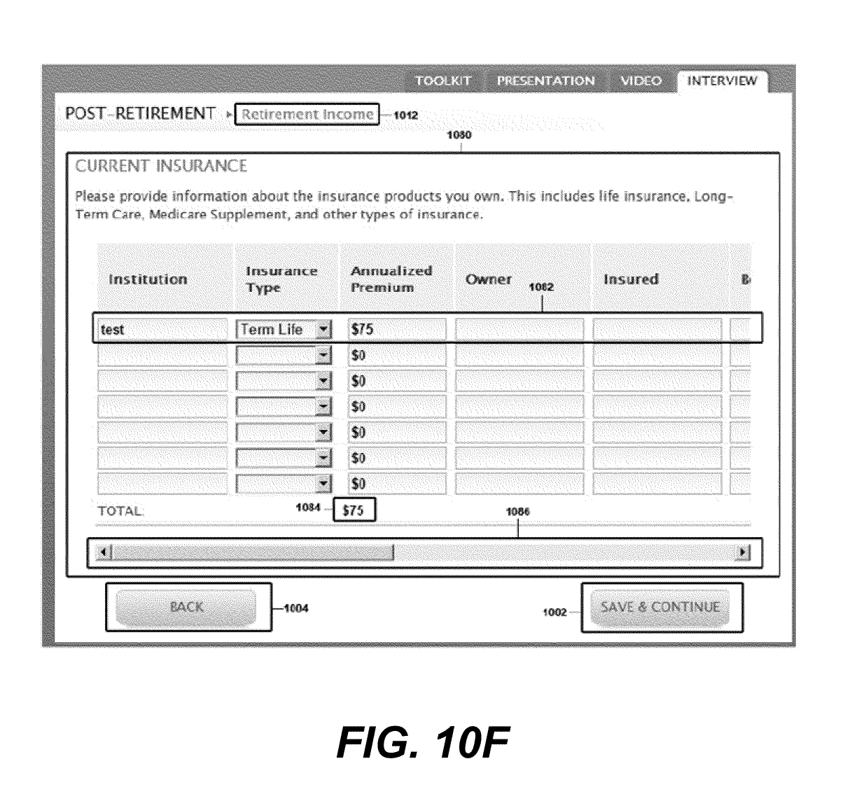

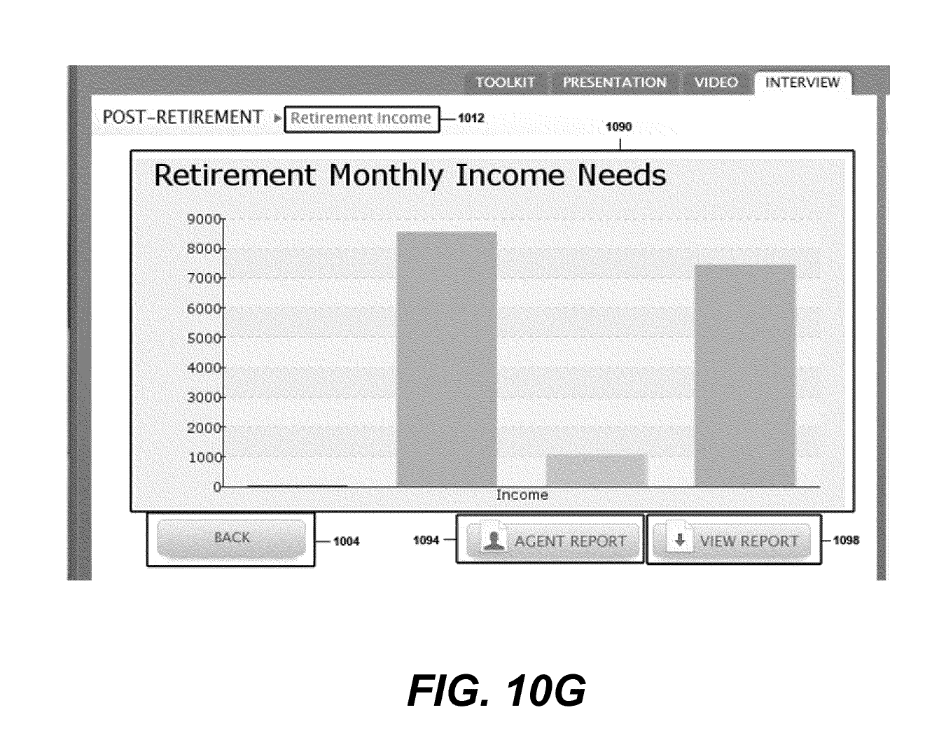

FIG. 10A-FIG. 10G are diagrams of illustrative display pages for implementing interactive methods and systems for the centralized software. In particular, FIG. 10A-FIG. 10G illustrate the Retirement Income sub-module 1012 in accordance with an embodiment of the centralized software. The Retirement Income 1012 sub-module may be accessed by clicking Retirement Needs 1010 link in the module bar 110.

The purpose of the Retirement Income sub-module 1012 is to provide an approximation of the amount of income a client would need to replace on retirement.

FIG. 10A illustrates an exemplary embodiment of the screen for displaying the fields for determining the retirement income for a client for the Retirement Income sub-module 1012. The Thoughts on Retirement 1030 section requests the user input thoughts on retirement. The statements by the user can be entered into the notes panel (not pictured in FIG. 10A).

FIG. 10A further illustrates the integration of the presentation layer. The Presentation 1020 in the Retirement Income sub-module 1012 will launch a customized presentation for evaluating the importance of retirement income and how to properly maximize and guarantee retirement income. A user may select Save & Continue 1002 to advance to the next screen for the Retirement Income sub-module 1012.

FIG. 10B illustrates the retirement objectives 1040 screen for the Retirement Income sub-module 1012. A user may select the level of importance it places on various objectives, such as, for example, preserving wealth and personal lifestyle 1042. Other objectives may also be presented by the retirement objectives 1040 screen. A user may select Back 1004 to go to the previous screen or click Save & Continue 1002 to advance to the next screen for the Retirement Income sub-module 1012.

FIG. 10C illustrates the Monthly Income 1050 screen for the Retirement Income sub-module 1012. The fields available for entry by the user for the Monthly Income 1050 screen include, for example, housing needs 1052A, utilities 1052B, food 1052C, transportation 1052D, and health care costs 1052E. These fields may also be prefilled by using the information presented in the budget worksheet accessed by the toolkit 702. Additional fields and screens may also be present within the Retirement Income sub-module to identify other expenses associated with calculating retirement income, such as, for example, insurance, gifts, and taxes. A user may select Back 1004 to go to the previous screen or click Save & Continue 1002 to advance to the next screen for the Retirement Income sub-module 1012.

FIG. 10D illustrates the Ongoing Income Sources 1060 screen for the Retirement Income sub-module 1012. The fields available for entry by the user for the ongoing income sources 1060 screen include, for example, salary wages and amount 1062. Other sources and types of income may be entered as desired by the user on the ongoing income sources 1060 screen. The total 1064 field is displayed and calculated for the user. A user may select Back 1004 to go to the previous screen or click Save & Continue 1002 to advance to the next screen for the Retirement Income sub-module 1012.

FIG. 10E illustrates the Financial Assets 1070 screen for the Retirement Income sub-module 1012. The fields available for entry by the user for the Financial Assets 1060 screen include, for example, amount of savings/cash and income from those assets 1072. Other sources and types of assets and their associated income may be entered as desired by the user on the financial assets 1070 screen. The assets total 1074 field displays the total for the assets and the monthly income total 1076 field displays the total monthly income for the user. FIG. 10E may contain additional information regarding the financial assets that can be entered by the user as demonstrated by the scroll bar 1078. A user may select Back 1004 to go to the previous screen or click Save & Continue 1002 to advance to the next screen for the Retirement Income sub-module 1012.

FIG. 10F illustrates the Current Insurance 1080 screen for the Retirement Income sub-module 1012. The fields available for entry by the user for the Current Insurance 1080 screen include, for example, the institution, type, premium, and death benefit, as well as various other fields 1082. The other fields can be accessed through the scrollbar 1086. Other sources and types of insurance may be entered as desired by the user on the Current Insurance 1080 screen. The total 1084 field displays the total premium 1084 and can display the total death benefit for the insurance for the user. Other screens may also be present in the centralized software to ascertain other financial information that may impact retirement, including, for example, a liabilities screen (not shown in figures) and a determine needs screen (not shown in figures), as well as other screens. A user may select Back 1004 to go to the previous screen or click Save & Continue 1002 to advance to the next screen for the Retirement Income sub-module 1012.

FIG. 10G illustrates a Retirement Monthly Income Needs 1090. The Retirement Monthly Income Needs 1090 graphically illustrates the monthly income needs for a user.

The Retirement Income sub-module 1012 may further generate an Agent Report 1094 that displays the client's projected retirement income. Similarly, the View Report 1098 link will generate a report for the client regarding the client's retirement income based on the various parameters entered in the screens for FIGS. 10A-10F, as well as any other screens for the Retirement Income sub-module 1012.

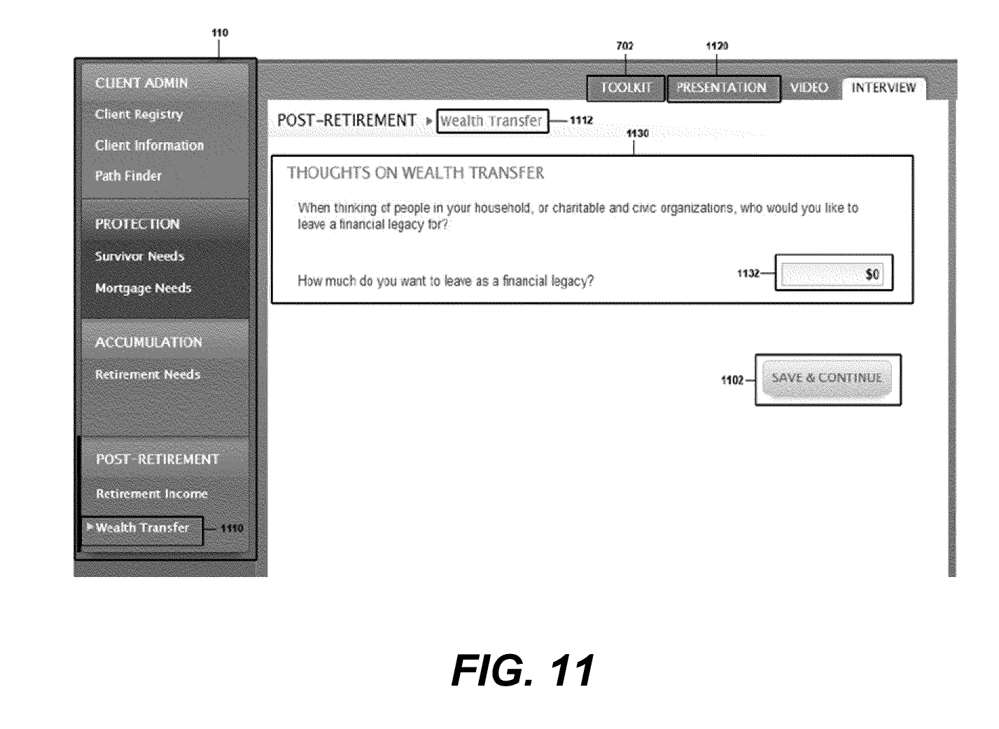

FIG. 11 is an illustrative display page for implementing interactive methods and systems for the centralized software. In particular, FIG. 11 illustrates the Wealth Transfer sub-module 1112 in accordance with an embodiment of the centralized software. The Wealth Transfer 1112 sub-module may be accessed by clicking Wealth Transfer 1110 link in the module bar 110.

The purpose of the Wealth Transfer sub-module 1112 is to help determine an efficient approach to transferring a lump sum or annual deposits to another party. On an example screen, such as Thoughts on Wealth Transfer 1130, the centralized software prompts the user to enter in the amount they would like to leave as a financial legacy 1132. The Wealth Transfer sub-module may then include further screens, including screens presented in the Retirement Income sub-module 1012, to assess the impact of the wealth transfer on the income statement and balance sheet of the client. A user may advance the screen by clicking on Save & Continue 1102 to go to the next screen for the Wealth Transfer sub-module 1112.

FIG. 11 further illustrates the integration of the presentation layer. The Presentation 1120 in the Wealth Transfer sub-module 1112 will launch a customized presentation for evaluating the impact of a wealth transfer on the user's retirement goals and allow for the selection of an appropriate strategy.

The Wealth Transfer sub-module 1112 may further generate reports for agents or clients regarding the impact of the wealth transfer on the income statement and balance sheet of the client. The Wealth Transfer sub-module 1112 would calculate this based on the information entered during the operation of the Wealth Transfer sub-module 1112. The data collected by the centralized software allows the user to better select an appropriate wealth transfer strategy.

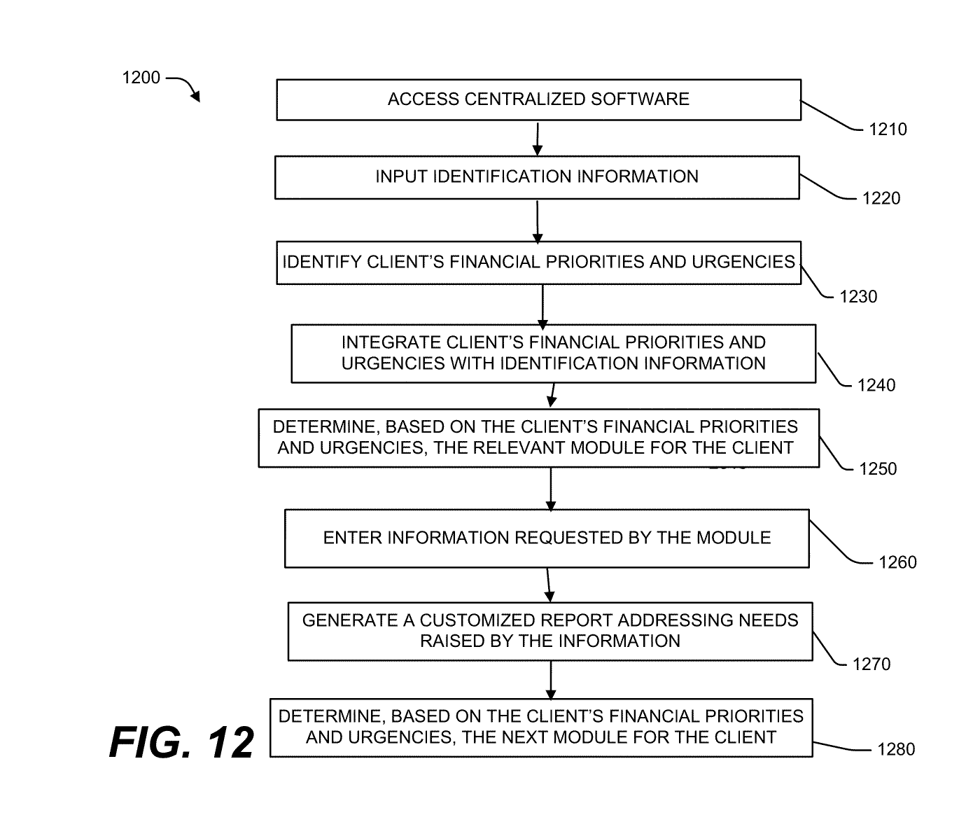

FIG. 12 illustrates a flow-chart of the operation of the centralized software 1200. A user may access the centralized software 1210 by clicking on the link via the desktop. Once the software launches, it may prompt the user to input client identification information 1220. Such information may include, for example, the information discussed in FIGS. 5A-5C. The centralized software may further request the user to identify the client's financial priorities and urgencies 1230. Such identification may be performed, in an exemplary embodiment, as described in FIG. 6. The centralized software can integrate the client's financial priorities and urgencies with the client identification information 1240 and determine, based on the client's financial priorities and urgencies, the relevant module for the client 1250. The relevant module may include any one or more of the modules and sub-modules discussed in relation to the figures above. Further, the description of the modules and sub-modules is not intended to be limiting, and this invention specifically encompasses developing other modules which may be associated with financial planning. The user is then prompted to enter information requested by the module 1260. Based on the information entered by the user, the centralized software generates a customized report addressing the needs raised within that module 1270 and may also present solutions. The agents can then discuss strategies for resolving those needs. Further, the centralized software may determine, based on the client's financial priorities and urgencies, the next relevant module for the client 1280 to address. The centralized software may then perform steps 1260 and 1270 for the next module or sub-module. Such actions can be taken for any number of modules until the user's financial needs have been addressed based on the priorities and urgencies identified by the user.

The centralized software also has a reporting capability to send the client record files to a remote home office. At the remote home office, the home office may consider the sales made for a particular client in comparison to the projected need for that sale. For example, a client which has a shortfall of $500,000 for survivor needs and only purchases a $25,000 policy would raise a flag for the home office. Other reporting capabilities can also be implemented within the scope of the invention.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of the present invention. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

1. A computer implemented method for providing a centralized software for financial planning, the method comprising:
displaying a plurality of data entry fields capable of receiving, within the centralized software, by a computer, client identification information comprising the identification of the client and family composition for the client;
receiving, by the centralized software, a set of inputs regarding financial priorities and urgencies for a client;
presenting, by the centralized software, a presentation layer, wherein the presentation layer includes presentations within the centralized software for illustrating concepts for a module;
wherein the centralized software determines the module that corresponds with the client's financial priorities and urgencies, wherein the module is further configured to:
receive data from data entry for financial goals for that module;
determine an amount needed by the client for reaching the financial goals for that module;
identify a shortfall between the amount needed by the client and the likely amount the client may reach based on current estimates; and
provide a recommendation for managing the shortfall.

2. The computer implemented method of claim 1, wherein the module includes at least one of a survivor needs module, mortgage needs module, retirement needs module, retirement income module, or wealth transfer module.

3. The computer implemented method of claim 1, wherein the centralized software further generates a report illustrating a client's financial profile.

4. The computer implemented method of claim 1, wherein each data entry field has a corresponding notes field within a notes panel, wherein the corresponding notes field is configured to receive notes regarding the data entry field.

5. The computer implemented method of claim 2, wherein the survivor needs module further determines an amount of life insurance needed, wherein the amount of life insurance needed is based, at least in part, on the shortfall.

6. The computer implemented method of claim 1, wherein the centralized software includes a budget worksheet for identifying a client's expenses, wherein the client's expenses entered are available for use by the one or more modules.

7. The computer implemented method of claim 2, wherein the retirement needs module projects a year in retirement wherein desired income falls below available income.

8. A system for providing a centralized software for financial planning, comprising:
an information handling system including at least one processor for processing data associated with a client;
a memory in communication with the processor for storing the data, wherein the memory includes a centralized software, where, when executed, the centralized software causes the at least one processor to:
present a display for displaying a plurality of data entry fields;
wherein the data entry fields are capable of receiving client identification information comprising the identification of the client and family composition;
receive input from the client indicative of the client's financial priorities and urgencies for a client;
provide a presentation layer, wherein the presentation layer includes presentations within the centralized software for illustrating concepts for a module;
wherein the module is selected based on the client's financial priorities and urgencies, further wherein the module is configured to:
receive data from data entry for financial goals for that module;
determine an amount needed by the client for reaching the financial goals for that module;
identify a shortfall between the amount needed by the client and the likely amount the client may reach based on current estimates; and
provide a recommendation for managing the shortfall.

9. The system of claim 8, wherein the module includes at least one of a survivor needs module, mortgage needs module, retirement needs module, retirement income module, or wealth transfer module.

10. The system of claim 8, wherein the centralized software further generates a report illustrating a client's financial profile.

11. The system of claim 8, wherein each data entry field has a corresponding notes field within a notes panel, wherein the corresponding notes field is configured to receive notes regarding the data entry field.

12. The system of claim 9, wherein the survivor needs module further determines an amount of life insurance needed, wherein the amount of life insurance needed is based, at least in part, on the shortfall.

13. The system of claim 8, wherein the centralized software includes a budget worksheet for identifying a client's expenses, wherein the client's expenses entered are available for use by the one or more modules.

14. The system of claim 9, wherein the retirement needs module projects a year in retirement wherein desired income falls below available income.

15. A method for providing a centralized software for financial planning, the method comprising:
providing an information handling system including at least one processor for processing data associated with a client using the centralized software; wherein a memory is in communication with the processor for storing the data;
displaying a plurality of data entry fields capable of receiving, within the centralized software, by a computer, client identification information comprising the identification of the client and family composition for the client;
receiving, by the centralized software, a set of inputs regarding financial priorities and urgencies for a client;
presenting, by the centralized software, a presentation layer, wherein the presentation layer includes presentations within the centralized software for illustrating concepts for a module;
wherein the centralized software determines the module that corresponds with the client's financial priorities and urgencies, wherein the module is further configured to:
receive data from data entry for financial goals for that module;
determine an amount needed by the client for reaching the financial goals for that module;
identify a shortfall between the amount needed by the client and the likely amount the client may reach based on current estimates; and
provide a recommendation for managing the shortfall.

16. The method of claim 15, wherein the module includes at least one of a survivor needs module, mortgage needs module, retirement needs module, retirement income module, or wealth transfer module.

17. The method of claim 15, wherein the centralized software further generates a report illustrating a client's financial profile.

18. The computer implemented method of claim 1, wherein each data entry field has a corresponding notes field within a notes panel, wherein the corresponding notes field is configured to receive notes regarding the data entry field.

19. The method of claim 16, wherein the survivor needs module further determines an amount of life insurance needed, wherein the amount of life insurance needed is based, at least in part, on the shortfall.

20. The method of claim 15, wherein the centralized software includes a budget worksheet for identifying a client's expenses, wherein the client's expenses entered are available for use by the one or more modules.
